(19) United States
(12) Patent Application Publication
(10) Pub. No.: US 2009/0077091 A1
(43) Pub. Date: Mar. 19, 2009

(54) SYSTEM FOR DEVELOPMENT AND HOSTING OF NETWORK APPLICATIONS

(76) Inventors: Gilad Khen, Haruzim (IL); Dan-El Khen, Haruzim (IL); Alon Weiss, Kiryat-Ono (IL)

Correspondence Address: FOLEY & LARDNER LLP, 150 EAST GILMAN STREET, P.O. BOX 1497, MADISON, WI, 53701-1497, US

(21) Appl. No.: 11/856,962

(22) Filed: Sep. 18, 2007

(51) Int. Cl. G06F 17/30

(52) U.S. Cl. 707/10; 707/E17.001

(57) ABSTRACT

A method of supporting an integrated development environment at a client device is provided. A request to access a network development platform is received at a server from a client device. The request includes an application identifier of an application to develop and an object identifier of an object associated with the application. Confirmation that an instance of a programmatic interface to a persistent storage associated with the application is executing at the server is performed using the application identifier. A service instance associated with the object is identified using the object identifier. The service instance is configured to modify a user interface of the client device to present the object. The identified service instance is sent to the client device.

### FIELD

The subject of the disclosure relates generally to systems and methods for the hosting and development of network applications.

### BACKGROUND

Web software development has proved to be one of the most complex and expensive processes in the software industry. It inherits its complexities from the various technologies and fields involved, including, for example, object-oriented and service-oriented development, client/server and hosted application development, data-centric and business application development, and rich application development. The large number of technologies involved steer most development efforts toward redundant tasks such as data persistence, serialization, state-management, synchronization, and user interface rendering. While many applications pose these similar challenges, lack of abstraction prevents from reusing solutions across separate implementations. While the need for a higher level of abstraction in web software development is one need filled by the systems and methods described herein, it is not the only need met by the exemplary embodiments.

### SUMMARY

Exemplary embodiments provide built-in capabilities for common web development tasks, exposed via a unified and extensible model. An online authoring environment is built on top of the platform, which in turn allows immediate creation of rich internet applications in a streamlined and optimized manner. The system architecture enables a higher level of abstraction during application design and execution, in order to alleviate the complexity involved in these processes.

An exemplary platform architecture augments traditional object-oriented models into full-fledged, self describing structures. Further, the platform can be described and implemented in code, which allows developers to retain the productivity gained by the abstraction, without compromising implementation agility. The platform exposes all its interfaces and gathers all its inputs via autonomic services.

In an exemplary embodiment, a method of supporting an integrated development environment at a client device is provided. A request to access a network development platform is received at a server from a client device. The request includes an application identifier of an application to develop and an object identifier of an object associated with the application. Confirmation that an instance of a programmatic interface to a persistent storage associated with the application is executing at the server is performed using the application identifier. A service instance associated with the object is identified using the object identifier. The service instance is configured to modify a user interface of the client device to present the object. The identified service instance is sent to the client device.

In another exemplary embodiment, a computer-readable medium is provided comprising computer-readable instructions that, upon execution by a processor, cause the processor to perform the operations of the method of supporting an integrated development environment at a client device.

In yet another exemplary embodiment, a device is provided. The device includes, but is not limited to, a processor, a memory, a communication interface, and the computer-readable medium. The memory operably couples to the processor. The communication interface operably couples to the processor to receive a plurality of files from a first device. The computer-readable medium operably couples to the processor. The computer-readable medium comprises instructions that, upon execution by the processor, perform the operations of the method of supporting an integrated development environment at a client device

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings.

FIG. 1 depicts a system that includes devices implementing a network development and hosting system in accordance with an exemplary embodiment.

FIG. 2 is a block diagram of a client device participating in the network development and hosting system in accordance with an exemplary embodiment.

FIG. 3 is a block diagram of a server device participating in the network development and hosting system in accordance with an exemplary embodiment.

FIG. 4 depicts a user interface of a network development platform based on the network development and hosting system of FIG. 1 in accordance with a first exemplary embodiment.

FIG. 5 depicts a user interface of a network development platform based on the network development and hosting system of FIG. 1 in accordance with a second exemplary embodiment.

FIG. 6 depicts the user interface of FIG. 5 presenting a view of a project in accordance with an exemplary embodiment.

FIG. 7 depicts the user interface of FIG. 5 presenting a view of a model in accordance with an exemplary embodiment.

FIG. 8 depicts the user interface of FIG. 5 presenting a view of a model module diagram in accordance with an exemplary embodiment.

FIG. 9 depicts the user interface of FIG. 5 presenting a view of a class in accordance with an exemplary embodiment.

FIG. 10 depicts a parsing process of the network development platform based on the network development and hosting system of FIG. 1 in accordance with a second exemplary embodiment.

FIG. 11 depicts the user interface of FIG. 5 presenting a view of a property in accordance with an exemplary embodiment.

FIG. 12 depicts the user interface of FIG. 5 presenting a view of a method in accordance with an exemplary embodiment.

FIG. 13 depicts the user interface of FIG. 5 presenting a view of a data object in accordance with an exemplary embodiment.

FIG. 14 is a block diagram of a client device infrastructure and a server device infrastructure implementing the network development and hosting system of FIG. 1 in accordance with an exemplary embodiment.

FIG. 15 depicts an HTML element hierarchy including a logical layer of the document in accordance with an exemplary embodiment.

FIG. 16 depicts an HTML element hierarchy including a data contextual layer of the document in accordance with an exemplary embodiment.

FIGS. 17a and 17b are a flow diagram depicting operations of a client serializer included as part of the network development and hosting system of FIG. 1 in accordance with an exemplary embodiment.

### DETAILED DESCRIPTION

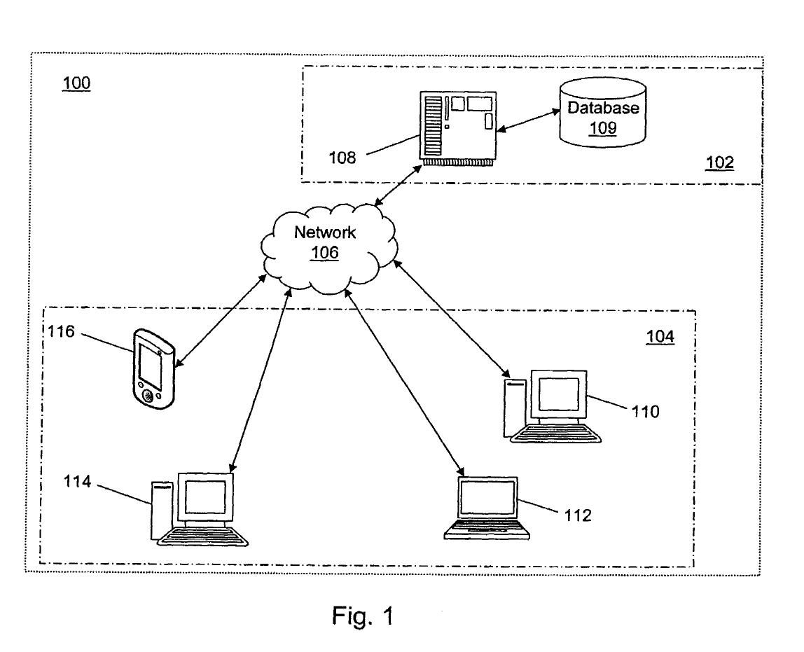

With reference to FIG. 1, a system diagram of a network development and hosting system 100 is shown in accordance with an exemplary embodiment. Network development and hosting system 100 may include a server system 102, a plurality of client devices 104, and a network 106. There may be fewer or additional networks in network development and hosting system 100. For example, network development and hosting system 100 may include a cellular network. Server system 102 may include a server 108 and a database 109. In an exemplary embodiment, network 106 is the Internet.

In network development and hosting system 100, the plurality of client devices 104 send and receive signals through network 106 to/from server system 102. Network development and hosting system 100 can include any number and type of client devices 104 that may be organized into subnets. The plurality of client devices 104 may include a first client device 110, a second client device 112, a third client device 114, and a fourth client device 116. The plurality of client devices 104 may include computers of any form factor such as a laptop, a desktop, an integrated messaging device, a personal digital assistant, a cellular telephone, an IPod, etc. Network development and hosting system 100 may include additional types of devices. The plurality of client devices 104 communicate using various transmission media that may be wired or wireless as known to those skilled in the art.

Server 108 includes or can access database 109 either through a direct connection or through a second network. Database 109 may include a plurality of databases that may be organized into multiple database tiers to improve data management and access. Database 109 is a data repository for network development and hosting system 100. Database 109 may utilize various database technologies and a variety of different formats as known to those skilled in the art including a file system, a relational database, and/or a system of tables, etc.

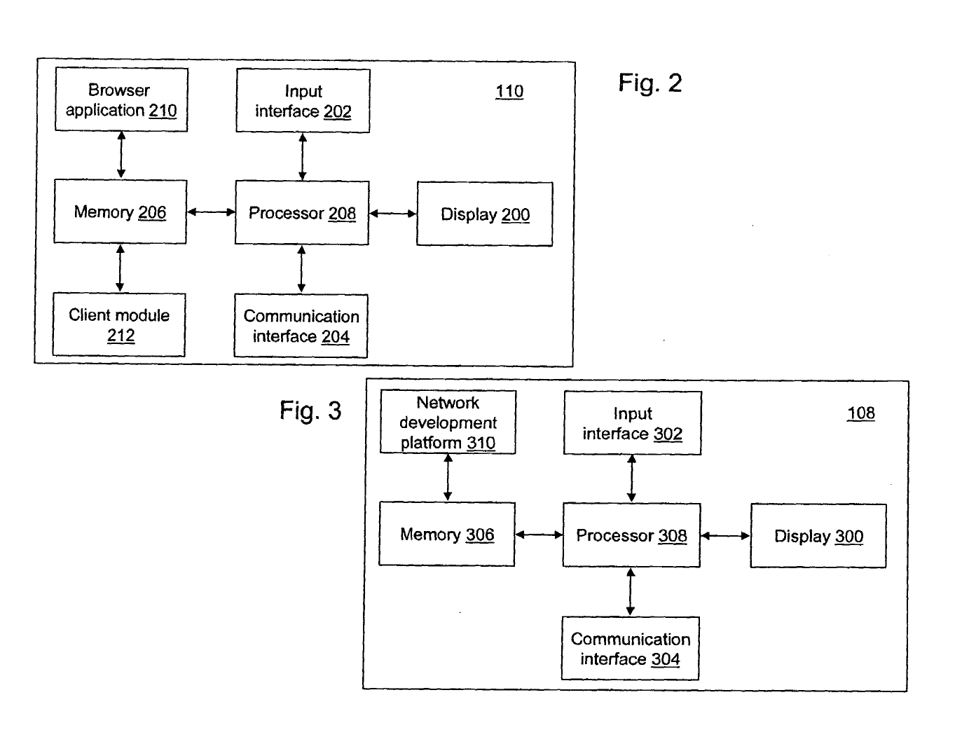

With reference to FIG. 2, a first client device 110 is shown in an exemplary embodiment. First client device 110 may include a display 200, an input interface 202, a communication interface 204, a memory 206, a processor 208, a browser application 210, and a client module 212. Different and additional components may be incorporated into first client device 110. For example, first client device 110 may include speakers for presentation of audio media content.

Display 200 presents information to a user of first client device 110 as known to those skilled in the art. For example, display 200 may be a thin film transistor display, a light emitting diode display, a liquid crystal display, or any of a variety of different displays known to those skilled in the art now or in the future. First client device 110 may include additional output device interfaces that use the same or different input technologies. For example, first client device 110 may include a printer.

Input interface 202 provides an interface for receiving information from the user for entry into first client device 110 as known to those skilled in the art. Input interface 202 may use various input technologies including, but not limited to, a keyboard, a pen and touch screen, a mouse, a track ball, a touch screen, a keypad, one or more buttons, etc. to allow the user to enter information into first client device 110 or to make selections presented in a user interface displayed on display 200. Input interface 202 may provide both an input and an output interface. For example, a touch screen both allows user input and presents output to the user. First client device 110 may have one or more input interfaces that use the same or different input technologies.

Communication interface 204 provides an interface for receiving and transmitting data between devices using various protocols, transmission technologies, and media as known to those skilled in the art. The communication interface may support communication using various transmission media that may be wired or wireless. First client device 110 may have one or more communication interfaces that use the same or different protocols, transmission technologies, and media.

Memory 206 is an electronic holding place or storage for information so that the information can be accessed by processor 208 as known to those skilled in the art. First client device 110 may have one or more memories that use the same or a different memory technology. Memory technologies include, but are not limited to, any type of random access memory (RAM), any type of read only memory (ROM), any type of flash memory, etc. First client device 110 also may have one or more drives that support the loading of a memory media such as a CD or DVD or ports that support connectivity with memory media such as flash drives.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with display 200, with input interface 202, with communication interface 204, and with memory 206 to receive, to send, and to process information. Processor 208 may retrieve a set of instructions from a permanent memory device and copy the instructions in an executable form to a temporary memory device that is generally some form of RAM. First client device 110 may include a plurality of processors that use the same or a different processing technology.

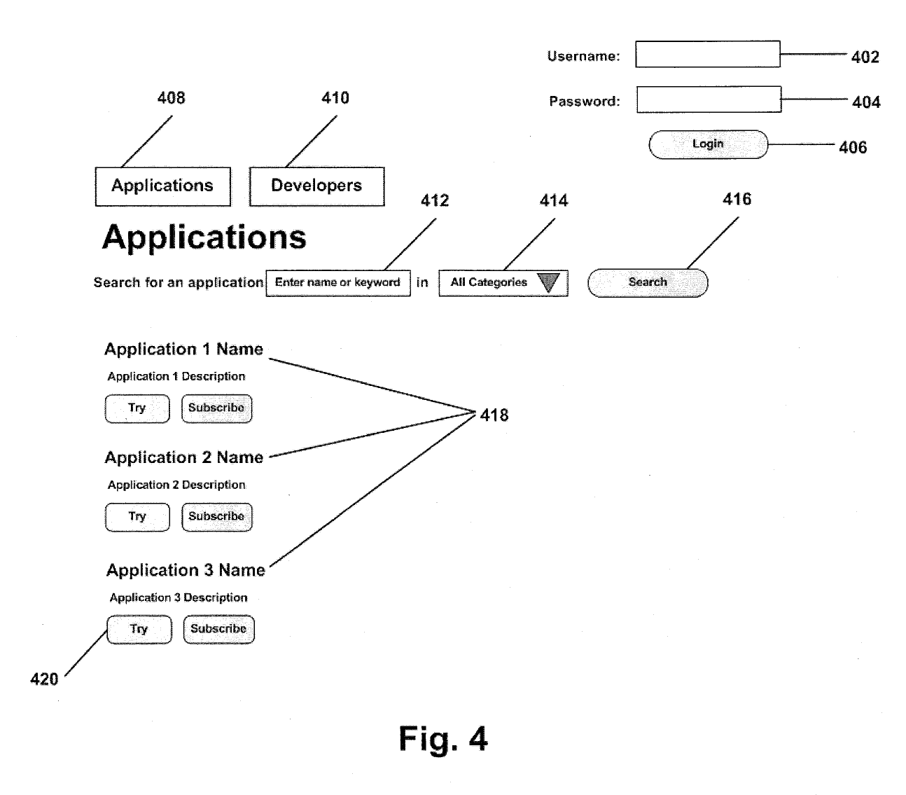

With reference to FIG. 3, server 108 may include a display 300, an input interface 302, a communication interface 304, a memory 306, a processor 308, and a network development platform 310. Different and additional components may be incorporated into server 108. Server 108 may comprise a plurality of computing devices.

Display 300 presents information to a user of server 108 as known to those skilled in the art. For example, display 300 may be a thin film transistor display, a light emitting diode display, a liquid crystal display, or any of a variety of different displays known to those skilled in the art now or in the future.

Input interface 302 provides an interface for receiving information from the user for entry into server 108 as known to those skilled in the art. Input interface 302 may use various input technologies including, but not limited to, a keyboard, a pen and touch screen, a mouse, a track ball, a touch screen, a keypad, one or more buttons, etc. to allow the user to enter information into server 108 or to make selections presented in a user interface displayed on display 300. Input interface 302 may provide both an input and an output interface. For example, a touch screen both allows user input and presents output to the user. Server 108 may have one or more input interfaces that use the same or different input technologies.

Communication interface 304 provides an interface for receiving and transmitting messages, files, and any other information communicable between devices using various protocols, transmission technologies, and media as known to those skilled in the art.

Memory 306 is an electronic holding place for information so that the information can be reached quickly by processor 308 as known to those skilled in the art. Server 108 may have one or more memories that use the same or a different memory technology. Memory technologies include, but are not limited to, any type of RAM, any type of ROM, any type of flash memory, etc.

Processor 308 executes instructions as known to those skilled in the art. The instructions may be carried out by a special purpose computer, logic circuits, or hardware circuits. Thus, processor 308 may be implemented in hardware, firmware, software, or any combination of these methods. Processor 310 executes an instruction, meaning that it performs the operations called for by that instruction. Processor 308 operably couples with display 300, with input interface 302, with memory 306, and with communication interface 304 to receive, to send, and to process information. Processor 308 may retrieve a set of instructions from a permanent memory device and copy the instructions in an executable form to a temporary memory device that is generally some form of RAM. Server 108 may include a plurality of processors that use the same or a different processing technology.

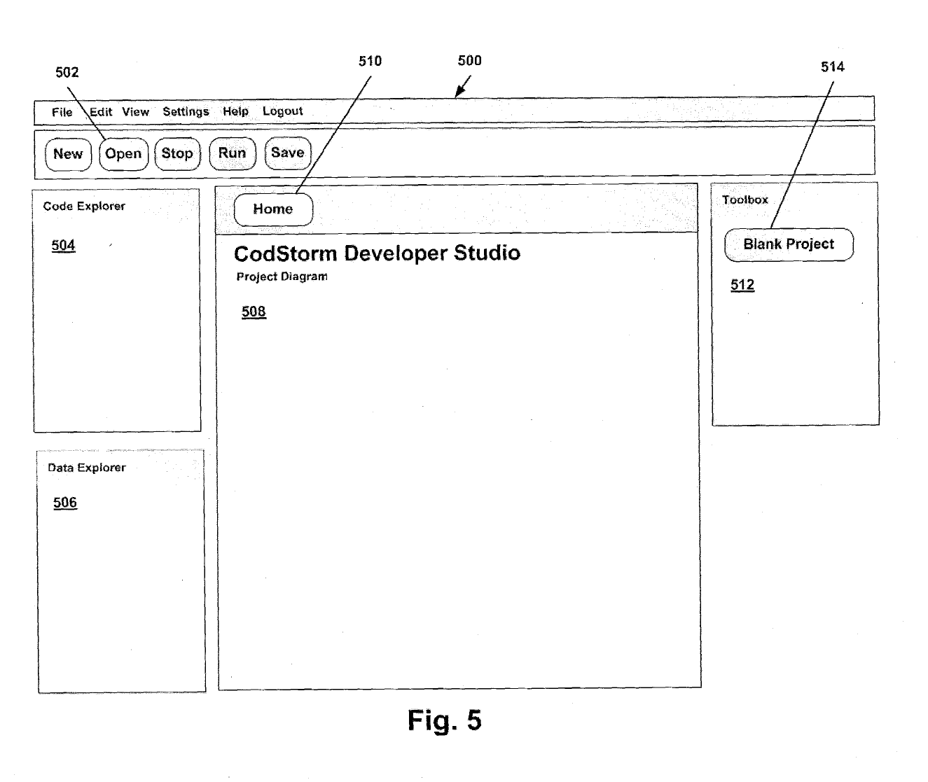

Network development platform 310 performs operations associated with developing, managing, and hosting network applications. Some or all of the operations and interfaces described with reference to FIGS. 4-17 may be embodied in network development platform 310. The operations may be implemented using hardware, firmware, software, or any combination of these methods. With reference to the exemplary embodiment of FIG. 3, network development platform 310 is implemented in software stored in memory 306 and accessible by processor 308 for execution of the instructions that embody the operations of network development platform 310. Network development platform 310 may be written using one or more programming languages, assembly languages, scripting languages, etc.

With reference to FIGS. 2 and 3, a user may use browser application 210 installed at first client device 110 to access network development platform 310 hosted at server 108. With reference to FIG. 4, a first user interface window 400 presented at display 200 under control of network development platform 310 is provided in accordance with an exemplary embodiment. First user interface window 400 may allow users at the plurality of client devices 104 to develop, manage, and execute rich Internet applications collaboratively through interaction with network development platform 310. Network development platform 310 may control the display of one or more web pages that present information to the user and from which the user may make selections or enter information. A web page may contain links to other web pages with related or additional information. Each web page is identified by a uniform resource locator that includes the location or address of the computer that contains the resource to be accessed in addition to the location of the resource on that computer. The type of file or resource depends on the Internet application protocol. For example, the hypertext transfer protocol (HTTP) may describe a web page to be accessed with browser application 210. Thus, network development platform 310 hosted at server 108 and browser application 210 hosted at first client device 110 may cause presentation of one or more user interfaces presented on display 200.

The user may login to server 108, as known to those skilled in the art, using a username textbox 402, a password textbox 404, and a login button 406. A user may select a desired functionality from an application link 408 and a development link 410. For example, user selection of application link 408 may present first user interface window 400 to a user of first client device 110. The user can search for an application using a search textbox 412, a category selector 414, and a search button 416. For example, the user may enter an application name or a keyword in search textbox 412 and select search button 416 to present a plurality of identified applications 418. User selection of a button 420 may allow the user to execute a selected application through browser application 210.

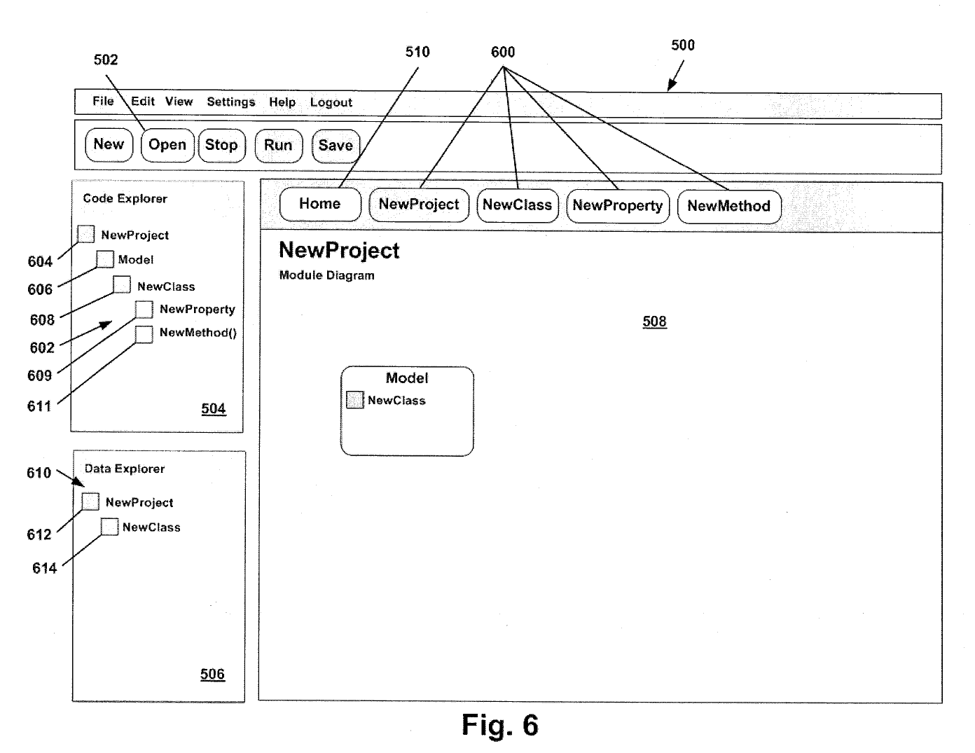

With reference to FIG. 5, user selection of development link 410 may present second user interface window 500 to the user of first client device 110. In accordance with an exemplary embodiment, second user interface window 500 may be presented at display 200 under control of network development platform 310 to support development and management of rich Internet applications. Second user interface window 500 may include a toolbar 502. Toolbar 502 may include a new button, an open button, a stop button, a run button and a save button. User selection of the new button may cause a new project to be opened for development of a new application. User selection of the open button may cause a window to open which allows the user to select from existing projects to be opened for continued development of an application. User selection of the run button may cause the selected application to execute. User selection of the stop button may cause the selected application to stop executing. User selection of the save button may cause the current state of the application development to be saved.

Second user interface window 500 further may include a plurality of user interaction windows. The plurality of user interaction windows may include a code explorer window 504, a data explorer window 506, a tab window 508, and a toolbox window 512. Code explorer window 504 may present a code structure tree view of the selected application. Data explorer window 506 may present a data tree view of the selected application. Tab window 508 may include information associated with one or more. For example, tab window presents information associated with a first tab 510. Toolbox window 512 may include information related to tools available based on items selected in code explorer window 504, data explorer window 506, and tab window 508. For example, toolbox window 512 includes a first project 514 selectable for development.

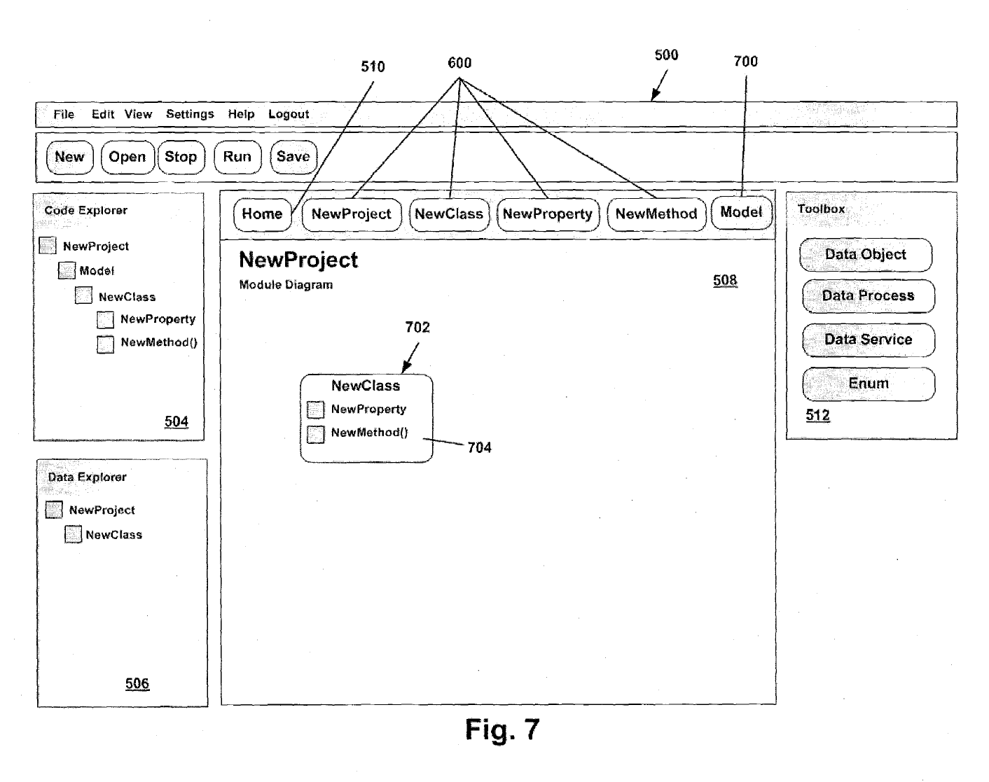

As an example, double-clicking first project 514 may cause a modification of second user interface window 500 as shown with reference to FIG. 6. A plurality of tab windows 600 can be selected by the user to present information related to the entity identified on the tab. Tab window 508 includes a module diagram of models included in first project 514. Code explorer window 504 includes a code structure tree view 602 associated with first project 514. At the highest level of code structure tree view 602 is a project identifier 604. Below project identifier 604 is a model identifier 606. Below model identifier 606 is a class identifier 608. Below class identifier 608 are identifiers for the properties and methods associated with the class. For example, a property identifier 609 and a method identifier 611 are shown below class identifier 608. Data explorer window 506 includes a data tree view 610 associated with first project 514. At the highest level of data tree view 610 is a data model identifier 612. Below the data model identifier 612 is a data object identifier 614. Double-clicking on an identifier in either code structure tree view 602 or data tree view 610 may cause creation of a new tab in tab window 508.

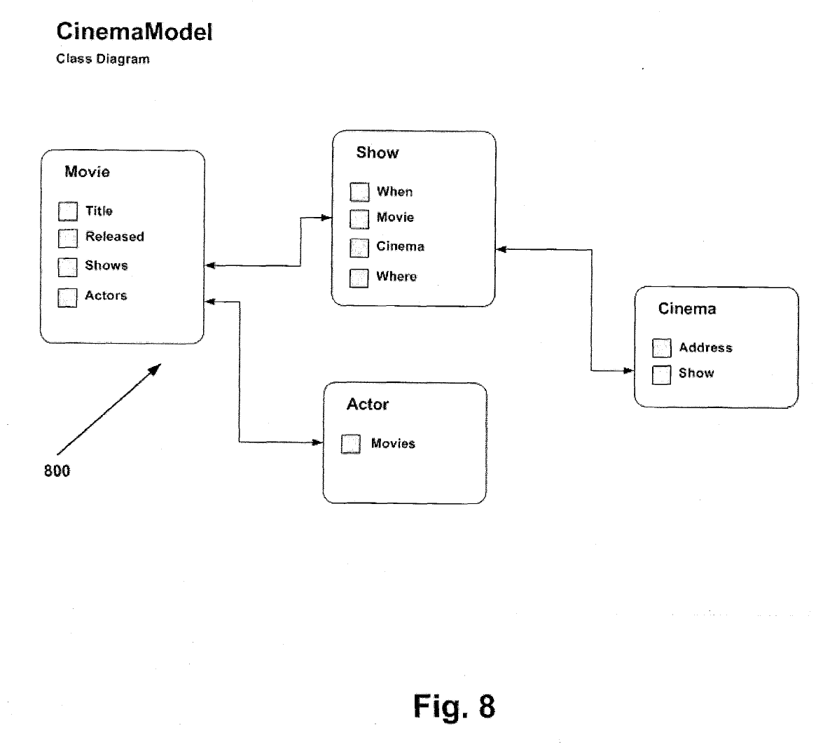

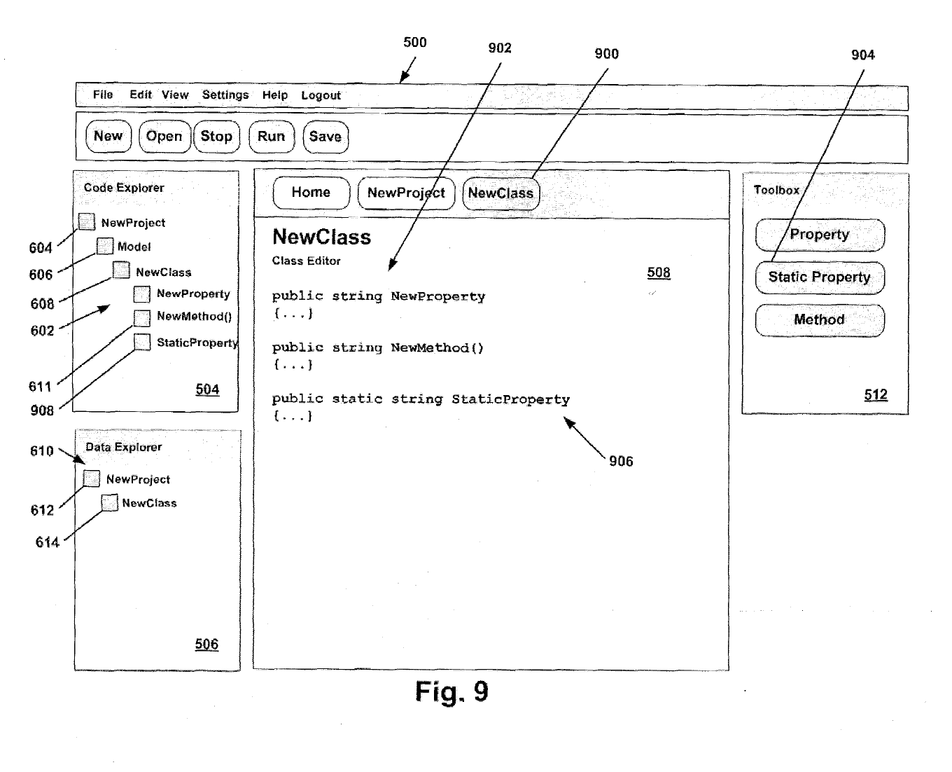

As an example, double-clicking model identifier 606 may cause a modification of second user interface window 500 as shown with reference to FIG. 7. A model tab 700 is created to present a model class diagram 702 in tab window 508. Model class diagram 702 includes a class module 704 that visually represents the classes included in the selected model. With reference to FIG. 8, a second model class diagram 800 is shown in tab window 508. Second model class diagram 800 includes a plurality of classes and arrows indicating linkages between the plurality of classes.

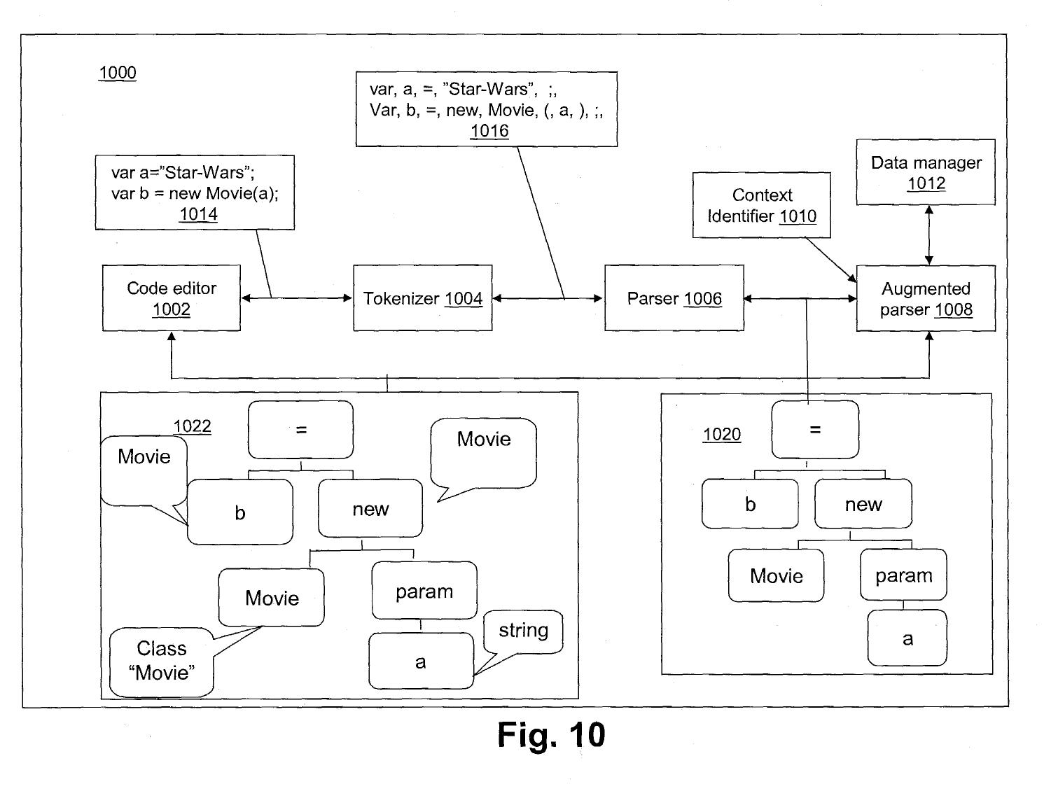

Double-clicking class identifier 608 may cause a modification of second user interface window 500 as shown with reference to FIG. 9. A class tab 900 is created to present code 902 associated with the selected class in tab window 508. The user can directly edit code 902 in tab window 508 by typing characters into the text window. Additionally, toolbox window 512 includes code elements that can be selected for insertion into the selected class. For example, double-clicking on a “Static Property” item 904 presented in toolbox window 512 causes a “Static Property” code block 906 to be inserted in the code presented in tab window 508 and causes a “Static Property” method item 908 to be added to code structure tree view 602.

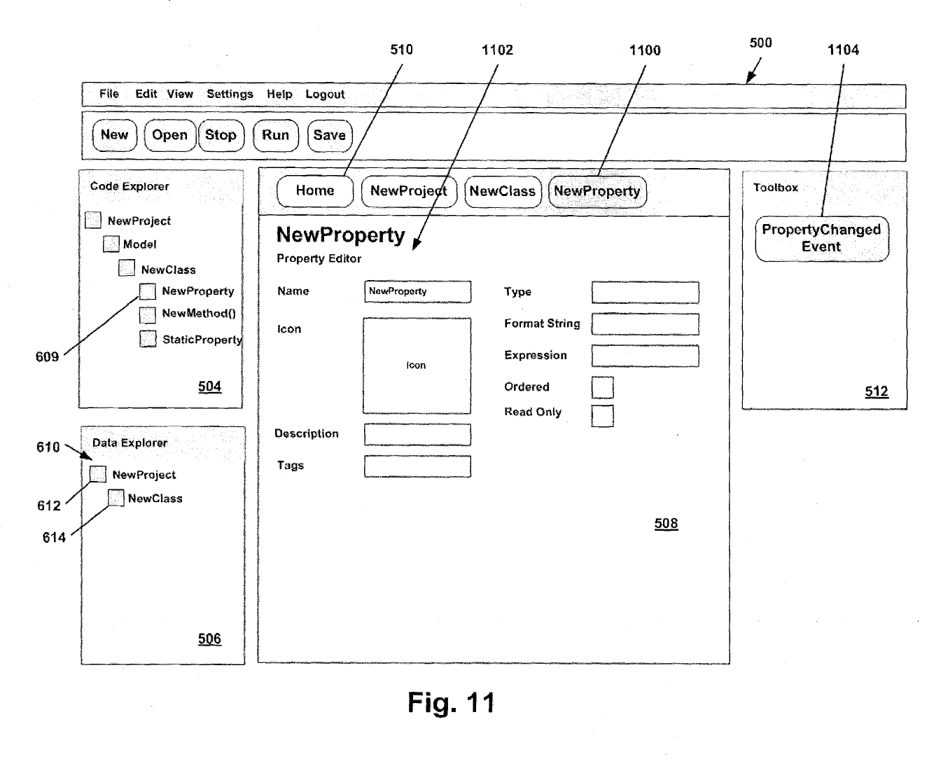

The class editing functions provide a dedicated code-writing environment with real-time code analysis, decoration, auto-completion, meta-model browsing, refactoring, conversion to other languages, error detection, and dependency checking. With reference to FIG. 10, a process 1000 that supports the dedicated code-writing environment in a networked environment is shown in accordance with an exemplary embodiment. Process 1000 may include a code editor 1002, a tokenizer 1004, a parser 1006, an augmented parser 1008, a context identifier 1010, and a data manager 1012. Code editor 1002 receives code characters 1014 entered by the user into tab window 508 and sends code characters 1014 to tokenizer 1004. Process 1000 occurs at first client device 110 when a user enters code, for example, by typing characters in tab window 508. When the user saves the code at first client device 110, the updated code is saved at server system 102 using processes detailed later. In an exemplary embodiment, code editor 1002 and data manager 1012 are implemented at first client device 110. Parser 1006, augmented parser 1008, and context identifier 1010 implemented at first client device 110 and/or server system 102.

Tokenizer 1004 receives code characters 1014 as an input stream of characters and outputs a stream of tokens 1016. Each token may be a one or more successive characters such as a comma, a number, whitespace, an identifier, a quoted string, etc. The stream of tokens 1016 may be saved by order or appearance and used to correlate the written text with the code document object model (DOM), to decorate the written text with colors based on the token type, and/or to provide auto-completion. In an exemplary embodiment, tokenizer 1004 is based on Mozilla Narcissus maintained by Mozilla.

Parser 1006 receives stream of tokens 1016 from tokenizer 1004 and constructs an abstract syntax tree 1020 according to the programming language used. In an exemplary embodiment, parser 1006 is based on Mozilla Narcissus maintained by Mozilla, with modifications to allow parser 1006 to parse partially or ill-written code. Parser 1006 also maintains internal references between tokens and the statements and expressions they represent. Each token is tagged with its role in the code where a role may be a keyword, a constant, a number, a string, a class name, etc.

Augmented parser 1008 receives abstract syntax tree 1020 from parser 1006. Augmented parser 1008 also receives a code context from context identifier 1010. A global context may be defined based on a type of an object (class) that owns a method. When the method is called at runtime, the “this” pointer points to the instance of the class that calls the method. The keyword used to refer to the “this” pointer varies among programming languages. For example, in some programming languages, the “this” pointer is referenced as “me” or “self”. A local context may be defined based on a set of identifiers defined outside the editable code, but accessible and visible to the user. For example, when a method is defined and edited, a signature of the method is not editable, but the signature defines the method parameters that should be included in the local context. Data manager 1012 provides a query mechanism on a meta-model to extract metadata associated with the code.

Augmented parser 1008 traverses abstract syntax tree 1020 using a depth-first-search, according to the order in which the code was written. For each identifier, augmented parser 1008 stores a list of possible values that may be acceptable during any of the possible runs. For example, if the following statement is written, var a=5, the identifier named “a” may be identified as a number. The information is added to abstract syntax tree 1020 to form an augmented abstract syntax tree 1022 defined by the augmented parser 1008 and sent to code editor 1002 to support real-time code analysis, decoration, auto-completion, meta-model browsing, refactoring, conversion to other languages, error detection, and dependency checking. If the following statement is then written, var b=a, the identifier named “b” may also be identified as a number, because “a” was a number. In this case, all of the possible values of “a” are added to “b”. Similarly, each statement in the abstract syntax tree 1020 is inspected to find its possible values. If the following statement is then written, var c=a+b+‘aaa’, the identifier named “c” may be identified as a string and this data is added to the augmented abstract syntax tree 1022. Depending on the programming language used, each statement may be a unary, a binary, a ternary, or an n-ary expression. A method call may be treated as an operand in these expressions.

Augmented abstract syntax tree 1022 is a multi-layered data structure with metadata that supports code decoration. Augmented parser 1008 also may provide a list of tokens such that each token references its corresponding node in augmented abstract syntax tree 1022. The list of tokens supports synchronization of code characters 1014 with the tokens. Each token is tagged with its role in the code, for example, a keyword, an identifier, or a parenthesis. A mapping function assigns a display class to each token using cascading style sheets which allow colors to be used to signify a parameters role in the code. Code editor 1002 colorizes each portion of the text presented in tab window 508 based on the assigned display class.

When the user types code characters 1014, code characters 1014 may be incomplete or incorrect. After a brief pause in typing by the user, process 1000 is performed to support code auto-completion. After completion of process 1000, augmented abstract syntax tree 1022 is evaluated to determine if code characters 1014 are valid and complete. If code characters 1014 are not valid and complete, code editor 1002 suggests one of three auto-completion modes. If the typed parameter is identified as an identifier reference, in a first auto-completion mode, augmented abstract syntax tree 1022 is traversed upward from the last token to identify all identifier definitions. An auto-complete visual control may be presented next to the cursor in tab window 508 with all possible identifiers, ordered alphabetically. When the programmer continues typing, the selection indicates a best match in the list. The user can select the correct identifier from the auto-complete visual control to complete the parameter.

Execution of process 1000 may be triggered upon user request, for example, using a known key sequence. Additionally or in the alternative, execution of process 1000 may be triggered automatically depending on the token that was typed after a brief pause. A brief pause may be a pause of 200-1000 milliseconds. Additionally or in the alternative, execution of process 1000 may be triggered immediately after selecting an item from a previous auto-complete text box.

If the typed parameter is identified as a method call, in a second auto-completion mode, augmented abstract syntax tree 1022 is traversed upwards from the last token until it reaches a method call node. From the method call node, all provided parameters are identified. The method information is displayed with the current parameter highlighted in a balloon next to the cursor in tab window 508. If the user continues typing, the highlighted parameter is updated. In an exemplary embodiment, if the user finishes a valid method call by typing the “)” character, the balloon is removed.

In a third auto-completion mode, the typed parameter is identified as a property reference by monitoring for a dot operator. When the user begins writing a property reference, the user uses the dot operator or the parallel. When a dot character is typed, code editor 1002 waits for augmented abstract syntax tree 1022 to be rebuilt. After augmented abstract syntax tree 1022 is rebuilt, code editor 1002 searches for possible values of the expression to the left of the operator. For each possible object type, its members are added to a visual control shown next to the cursor in tab window 508. If the user continues typing, the selection presented indicates the best match in the list.

After code characters 1014 are synchronized with augmented abstract syntax tree 1022, each token refers to a corresponding node in augmented abstract syntax tree 1022. Clicking with the mouse on a token, while pressing the “ALT” key, may cause display of a balloon with information related to that node in augmented abstract syntax tree 1022. The information may include an identifier, a property, and/or method information. While the balloon is displayed, the token is highlighted with a distinct formatting, and when the programmer releases the “ALT” key, the balloon disappears. As a result, process 1000 supports token inspection by the user in tab window 508.

Process 1000 also supports refactoring, which is the process of modifying code automatically to rename variables, to change a parameter order, and/or to externalize code. Refactoring is performed by finding references to a refactored object, changing it, and then changing the refactored object itself. Process 1000 also supports dependency checking to determine a subset of the context which influences a value of a specific piece of code outside the specific piece of code. Dependency checking is a recursive process that allows the system to optimize itself and refrain from subscribing to too many low-level events. For example, a user-written code may access several members of instances of objects. If the code executes at the client, lazy-loading may slow down the process. Network development and hosting system 100 provides code analysis services to detect this type of situation to obtain the required data prior to running the code

Process 1000 also supports error detection. For example, if a method that returns an integer has a return statement that returns a “Movie” instance, this may be considered an error. The user may be visually notified of this error. Process 1000 also supports a conversion to other computer languages, to other dialects of the same language, or to another runtime by serializing augmented abstract syntax tree 1022 with the required syntactic changes.

A “what-you-see-is-what-you-get” (WYSIWYG) markup editor may operate using similar techniques; however, the WYSIWYG markup editor may provide an additional editing and viewing mechanism. The main difference between the WYSIWYG markup editor and code editor 1002 is the location of the abstract model that stores the code in memory. Using code editor 1002, the model is continuously updated using process 1000, whereas using the WYSIWYG markup editor, the WYSIWYG markup editor serves as the bridge and provides common interfaces between both a textual and a visual editor. When one editor changes the abstract model, the other editor reflects the changes in its view. For this purpose, an extended document object model (DOM) model is defined to support events and automatic event-firing mechanisms. When the model is changed, an event is automatically generated and sent to the other editor. Partial parsing provides dramatic performance improvements when writing the markup by hand due to the tree-like structure of the markup. Several heuristics can be performed when parsing the code. Specifically, the updated region can be restricted to the most common ancestor of the updated region. That region can be parsed and replace the “old” sub-tree. As a result, only one event is fired instead of an event for each node in the replaced tree.

When modifying the model using the visual tools (such as resizing, property editing, addition of nodes using drag & drop), the reverse process of partial parsing occurs. A sub-tree of the model changes and the markup editor reflects the model changes. The purpose is the same: avoiding a complete re-write, or redraw, of the code with resulting performance improvements. This functionality is achieved by storing the tokens as a linked list, by storing whitespace tokens and comments in addition to the tokens, and by writing a custom serializer that takes a sub-tree of a markup and writes it back to text. Each token has a reference to the node it represents. Similarly, each node stores the first and last tokens that the node is built from. When a sub-tree changes, all the tokens between its endpoints are deleted and new ones are created, with proper references to the newly created sub-tree.

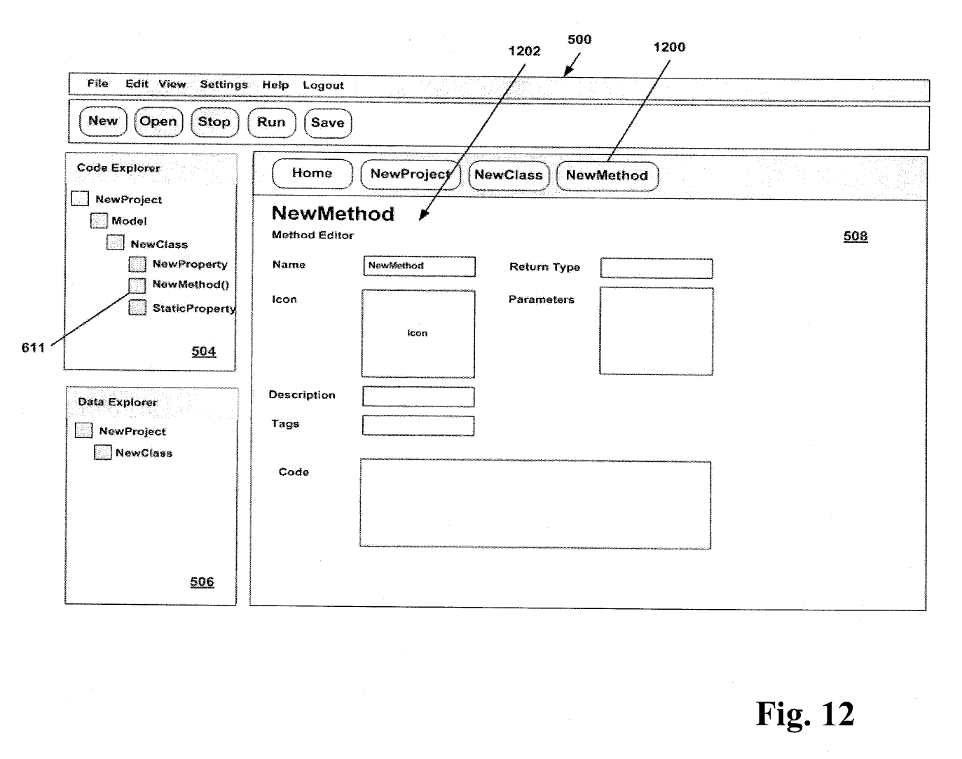

Double-clicking property identifier 609 may cause a modification of second user interface window 500 as shown with reference to FIG. 11. A property tab 1100 is created to present definitional controls 1102 in tab window 508 associated with the selected property. The user can enter data into and make selections from definitional controls 1102 in tab window 508 to define the characteristics of the selected property. For example, the user can define a name, an icon, a description, tags, identify property type characteristics, select an event handler for the property and metadata associated with the property using definitional controls 1102.

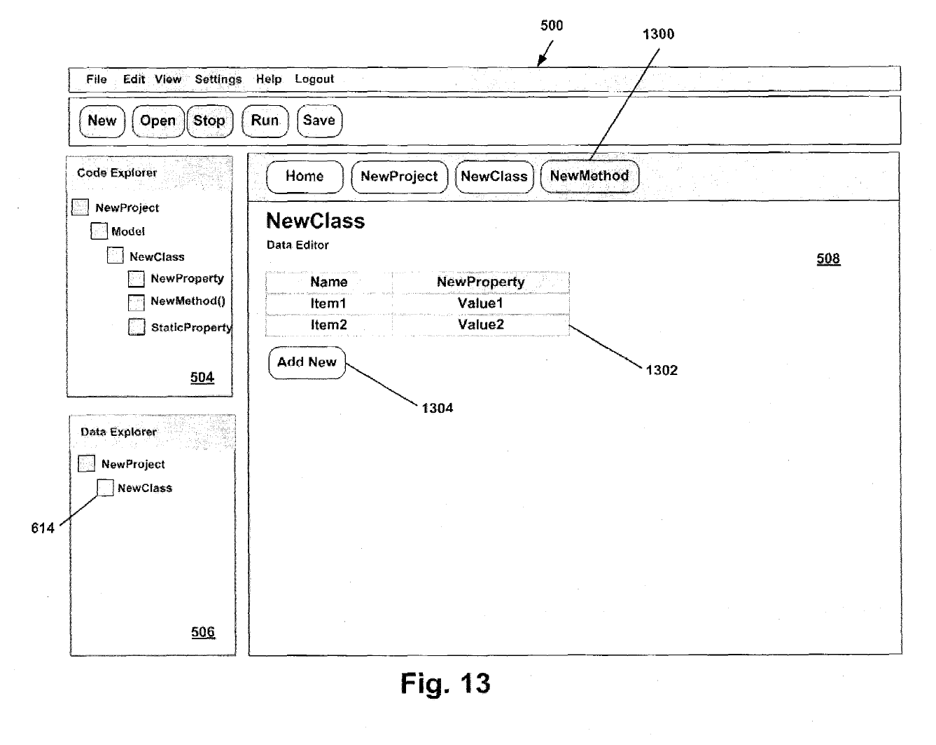

Double-clicking method identifier 611 may cause a modification of second user interface window 500 as shown with reference to FIG. 12. A method tab 1200 is created to present method definitional controls 1202 in tab window 508 associated with the selected method. The user can enter data into and make selections from method definitional controls 1202 in tab window 508 to define the characteristics of the selected method. For example, the user can define a name, an icon, a description, tags, identify any parameters and a return type, and define the code associated with the method using definitional controls 1102.

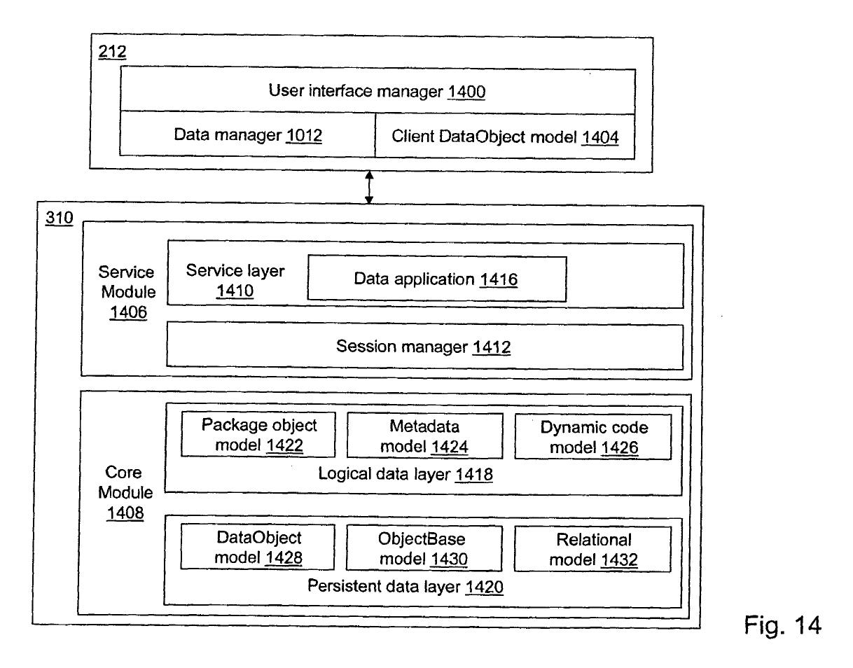

Double-clicking data object identifier 614 may cause a modification of second user interface window 500 as shown with reference to FIG. 13. A data object tab 1300 is created to present a data table 1302 in tab window 508. The user can enter data into data table 1302 in tab window 508 to define a class instance. The user can create another class instance by selecting an add button 1304.

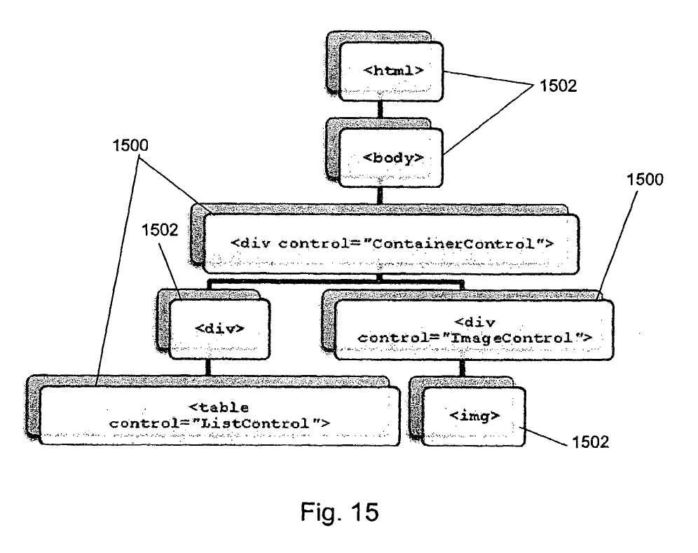

With reference to FIG. 14, functional components of network development platform 310 and client module 212 are shown in accordance with an exemplary embodiment. Client module 212 may include a user interface (UI) manager 1400, data manager 1012, and a client data object model 1404, which, for example, support presentation of second user interface window 500. A UI model defines the elements that construct the presentation layer at first client device 110 and augments the basic physical world wide web consortium HTML model with a logical abstract layer and a data contextual abstract layer. The UI model is maintained by UI manager 1400, which handles logical control rendering within the physical document layer.

The UI Model may include three sub-models: a document object model, a document control model, and a document data context model. The document object model defines the hierarchy of the HTML elements that compose the physical layer of the document. This layer is typically implemented and rendered by browser application 210.

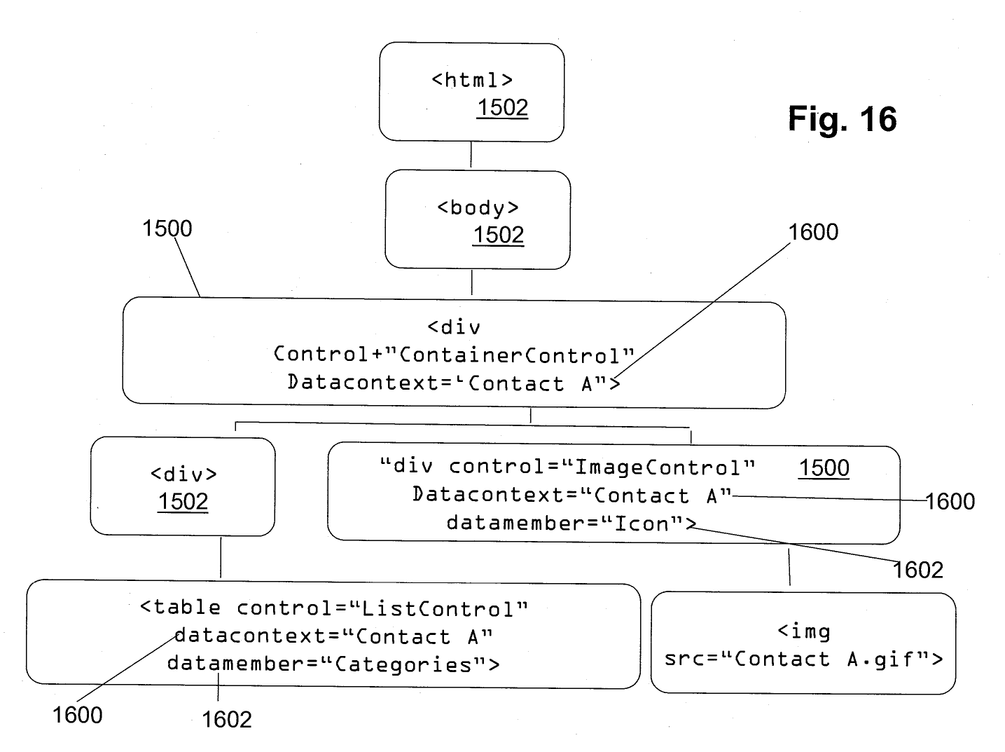

The document control model defines the hierarchy of the HTML elements that compose the logical layer of the document. Each control represents a set of HTML elements associated with a single logical unit. This layer is implemented and rendered by UI manager 1400. Control rendering can recursively trigger the rendering of additional physical elements, which in turn can result in additional nested logical controls. For example, with reference to FIG. 15, control hierarchy elements 1500 are shown interleaved with HTML physical layer elements 1502. The document control model builds on top of the physical layer to add abstract logical functionality by associating a group of physical elements with a single logical unit. For example, a simple <div> element can be associated with a select-box by attaching an HTML attribute such as control=“SelectBox”.

A logical control layer is created on demand by UI manager 1400 in a process referred to as control rendering. The control rendering process is second to the physical rendering process performed by browser application 210 when transforming HTML elements into actual pixels. The control rendering process may be performed by recursively invoking a “RenderControl” method provided by UI manager 1400. The “RenderControl” method receives at least a root physical element to traverse. The “RenderControl” method tests a physical element for a control attribute. If a physical element is found, appropriate logical control is instantiated as annotated in the attribute value, and the “RenderControl” method is invoked, passing a manager and a target physical element as parameters. The “RenderControl” method also tests the physical element for a “RendersOwnContent” attribute. If a “RendersOwnContent” attribute is found, the rendered control instance is returned. If a “RendersOwnContent” attribute is not found, any immediate physical child elements are traversed, and the “RenderControl” method is invoked, passing the child element as the parameter. The “RenderControl” method also tests the physical element for an “on Rendered” attribute. If an “on Rendered” attribute is found, the code annotated in the attribute value is evaluated to allow non-logical elements to participate in the logical rendering process. The “RenderControl” method returns the rendered control instance.

Each control can implement its own custom rendering logic. This logic may include performing dynamic changes to the underlying physical layer to achieve a desired functionality and display. This behavior may be triggered by the overlying data context layer traversing the logical layer.

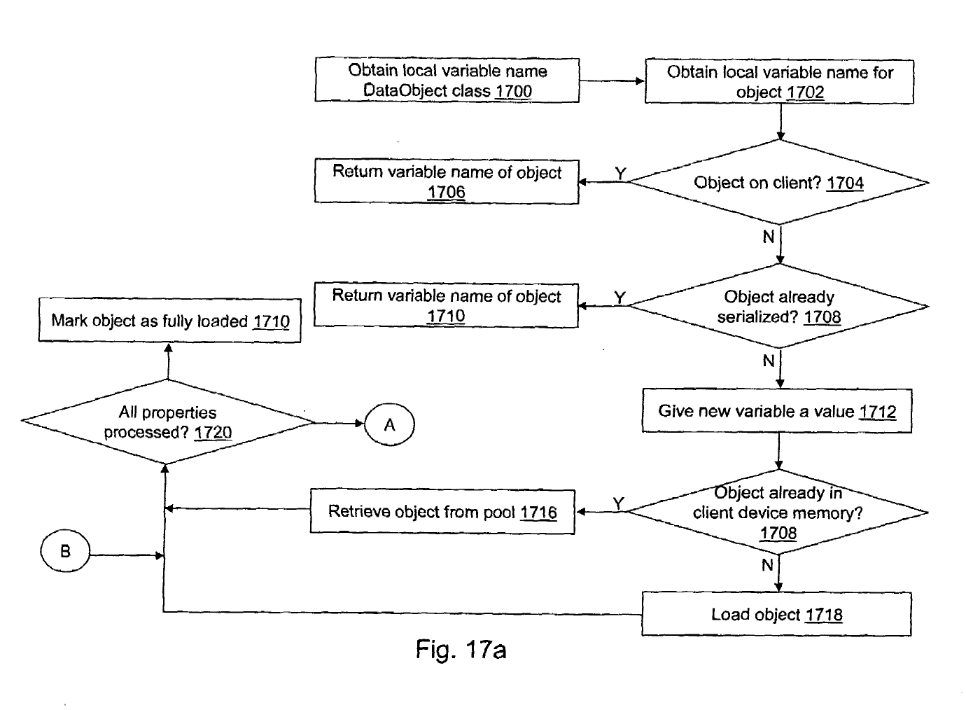

The document data context model defines the data object hierarchy that composes the data contextual layer of the document. Each control is associated with a data object in its context. This layer is maintained by the controls themselves. By default, container controls propagate their assigned data context downwards until it reaches an atomic, non-container control. For example, with reference to FIG. 16, data context hierarchy elements 1600 and data member paths 1602 are shown interleaved with the control hierarchy elements 1500 and the HTML physical layer elements 1502. Each control is associated with a data object in its context, and has the choice of propagating a context downwards to its child controls. In turn, each child control can choose to either accept or reject data context propagated to it, as defined in its “InheritsDataContext” attribute.

Data context is a single instance of a data object. The data object may be local to first client device 110 or remote from first client device 110, for example at server 108. In that sense, the control is said to be bound to its data context. Each control exposes a data binding interface which includes a data context for the control (“DataContext”); a class of the data context instance designated to be assigned the control (“ClassPath”); a relative member path from the control data context class (“MemberPath”); a data context member value as denoted by a member path or the data context itself when the member path is null (“ControlValue”); a control value after it has been parsed by the control (“InternalValue”); and a class or a member representing the control value type (“MemberElement”). For example, a data binding interface may include <div control=“TextBox” classpath=“Contact” memberpath=“FirstName”/>.

Metadata elements are available as first-class data objects in client module 212. As a result, data-bound controls can perform metadata queries on their underlying member elements for usage in various implementation algorithms. In the example above, the “TextBox” control can request any of formatting metadata to format the given value for display; masking metadata to filter out invalid input characters; validating metadata to determine whether a given input is valid; styling metadata to adjust the display to match the bound data; synchronizing metadata to determine how to propagate value modifications to the bound object and server 108. Additionally, composite controls such as tree views and menus can query for more specific metadata to display structured data properly. For example, a table control can query for “IsBrowsable” metadata to determine whether or not to display a given property column. In an exemplary implementation, controls query metadata using a metadata matching algorithm built-into client module 212.

The document data context model tunnels across the logical layer according to the following exemplary process. A “SetDataContext” method is invoked for a control, passing an instance of a data object as a parameter. The data object is tested for a “MemberPath” attribute. If a “MemberPath” attribute is found, the “ControlValue” parameter is updated to define the data context based on the “MemberPath” attribute. If a “MemberPath” attribute is not found, the “ControlValue” parameter is updated to define the data context based on the “DataContext” parameter itself. An “InternalValue” is set to the parsed “ControlValue” parameter. The data object is tested for a “Tunnel DataContext” attribute. If a “Tunnel” attribute is found, immediate logical child controls are identified and iterated over. For each child control identified, the child control is tested for an “InheritsDataContext” attribute. If an “InheritsDataContext” attribute is not found or is set to true, a “SetDataContext” method is invoked for the child control, passing the control value as a parameter. Using this process, the data context model can be traversed by propagating control values as context to logical child controls.

Certain controls such as buttons, can bind to non-data members such as methods. When a button is bound to a method, it invokes that method according to the metadata information available at execution context. If the method requires parameters, client module 210 may assist in collecting those parameters using further binding definitions. This is the presentation layer meaning of a control bound to a method. Method binding may include, at runtime, assigning a data method instance to each data object instance and method element pair. The data method object acts as a first-class data object and the parameters are its properties. Data methods also expose an owner property member that allows access back to the associated data object instance and an invoke method member that allows triggering of the invocation for the method based on its associated owner. Method execution can occur either on first client device 110 or server 108.

At the top of the control model inheritance hierarchy are three base classes: a “Control” base class, a “ContainerControl” base class, and a “ListControl” base class. The “Control” base class is the base class for data-bound control types. By default, its “RendersOwnContent” is set to true, so UI manager 1400 delegates the rendering logic to the control itself. The “ContainerControl” base class is the base class for all data-bound container control types. By default, its “RendersOwnContent” is set to false, so UI manager 1400 traverses its DOM to render its internal controls. The “ListControl” base class is the base class for all collection-bound control types. By default, its “RendersOwnContent” is set to true, so UI manager 1400 delegates the rendering logic to the control itself.

List controls encapsulate logic for interfacing with collections. A list control can be assigned with a collection value directly by handing the control a collection data property object. The list control considers the data property object itself as the target collection. A list control can be assigned with a collection value indirectly by handing the control a data object instance, and defining the “MemberPath” attribute to be a pointer property. The list control considers a “PossibleValues” collection retrieved from the property as the target collection. A list control also can be assigned with a collection value indirectly by handing the control a data object instance, and defining the “MemberPath” attribute to be a collection property. The list control tests for an “IsLookup” attribute. If an “IsLookup” attribute is found, the list control considers the “PossibleValues” collection retrieved from the property as the collection. If an “IsLookup” attribute is not found, the list control considers the data property object as the collection. The behavior can be overridden in derived classes or via metadata.

Once a list control has been assigned a collection, the list control queries data manager 1012 for a client data view. Client data views provide a level of abstraction on top of collection properties to provide: paging, sorting, filtering, and selecting functionality. Associated with paging, the list control displays the items in the current data view page. Associated with sorting, the list control displays the items in the order they appear in the view instead of in the collection. Associated with filtering, the list control displays the items that match the data view criteria. Associated with selecting, the list control coordinates its selection with the data view selection.

A client data view is a first-class data object that may be remote or local to first client device 110. As such, client module 212 data view exposes its structured interface, to be used by common data binding infrastructure. Each client data view exposes the following interface: a “PageIndex” property which denotes the index of the current view page; a “PageSize” property which denotes the size of the current view page; a “PageCount” property which denotes the number of pages in the current view; a “NextPage” property which increments the current “PageIndex” property value, if possible; a “PrevPage” method which decrements the current “PageIndex” property value, if possible; a “NextPage” method which sets the current “PageIndex” property value to zero; a “LastPage” method which sets the current “PageIndex” property value to the “PageCount” property value; a “Criteria” property which denotes a filter expression for the current view; a “SortBy” property which denotes a sorting expression for the current page view; and a “SelectedItems” property which denotes the currently selected items for the view. Additionally, each client data view exposes the following data binding interface methods: an “AddItem” method which adds a given item to the underlying collection; a “RemoveItem” method which a given item from the underlying collection; and a “AddNewItem” method which creates a new item and adds it to the underlying collection.

Data manager 1012 handles communication with server 108. Data manager 1012 retrieves data, maintains object singularity, requests execution of remote methods, and processes server instructions that update client module 212 state at first client device 110. Data manager 1012 is a proxy object of a “DataWebService” of network development platform 310. Data manager 1012 exposes the same application programming interface (API) as the “DataWebService”. The API includes an “InvokeMethod” method which accepts a target parameter, a method name, and an array of parameters associated with the method which is being invoked. The target parameter may have a “DataObject” data type. The method name may be a string. A primitive value, a “DataObject”, or a collection may be returned by the “InvokeMethod” method.

When a call is made to the “InvokeMethod” method, the method transforms the call to a valid “DataWebService” request, sends the request to server 108, receives a response from server 108, processes the response by following the server's instructions included in the response, and returns the response's evaluated return value. As a result, client module 212 can invoke any method at network development platform 310. The method may be global, static, or instance methods. When data manager 1012 receives the response, data manager 1012 suspends all created “DataObjects” events to prevent any logic from occurring until the processing is complete. Any event that should occur during processing is pooled. Data manager 1012 evaluates the instructions returned in the response. The instructions may be a creation of new instances, modifications to existing instances, the return value, and any other instructions. After processing, data manager 1012 resumes the suspended events and triggers pending events.

When network development platform 310 instructs client module 212 to create a “DataObject”, data manager 1012 receives an identifier for the new instance and a reference to a “ClassElement” object. Data manager 1012 checks if the class has a scripted implementation and traverses up the base classes until it finds the class. The “DataObject” class is linked to a scripted implementation of “DataObject”, so there is an implementation available. Data manager 1012 creates the proper instance locally, assigning the local instance a class reference and identifier. Data manager 1012 includes the newly created instance in a pool of objects based on the identifier.

Client DataObject model 1404 enables access to local and remote data using a common interface. The client module 212 implementation of “DataObject” allows the creation of remote and local “DataObjects”. Remote “DataObjects” are “DataObjects” created by network development platform 310 and stored at server 108, possibly in database 109. When client module 212 attempts to invoke a method on a remote “DataObject”, the “DataObjects” use data manager 1012 to invoke that method on server 108 and to return the return value from the invoked method. When client module 212 attempts to read a remote property value of a “DataObject”, the “DataObject” check if the property value is loaded. If the property value is not loaded, the “DataObject” use data manager 1012 to load that property, and return the property value.

With continuing reference to FIG. 14, network development platform 310 may include a service module 1406 and a core module 1408. Service module 1406 communicates with client module 212. Core module 1408 implements a live object model, its metadata, and its persistence to database 109. Core module 1408 stores the data and code that network development and hosting system 100 uses. Service module 1406 may include a service layer 1410 and a session manager 1412. Service layer 1410 provides an interface between client module 212 and the deeper layers of network development platform 310. Service layer 1410 initiates and ends communication sessions with client module 212 and transfers data between client module 212 and the deeper layers. In an exemplary embodiment, service layer 1410 listens for and responds to HTTP requests from the plurality of client devices 104 over network 106. Session manager 1412 records information about each communication session between client module 212 of the plurality of client devices 104 and the deeper layers. Session manager 1412 also propagates changes in the data to and from client module 212, when necessary. In an exemplary embodiment, session manager 1412 ensures that the most recent data is available when needed, while at the same time minimizing the amount of synchronization traffic on network 106.

In an exemplary embodiment, service layer 1410 includes a data application 1416. Service layer 1410 provides two endpoints: a first endpoint, where client module 212 receives a payload of data that may include framework scripts, libraries, graphics and markup; and a second endpoint by which client module 212 receives data and performs operations on that data. The data may be any data object including data and metadata.

In an exemplary embodiment, session manager 1412 maintains a state for each client module 212 called a “DataSession”. The state holds information about the data client module 212 has received and of which client module 212 is aware. Network development platform 310 keep track of the changes that occur on the data and updates client module 212 with those changes. The updates can be done upon request (for example, by polling the server), piggy-backed on a response of a method invocation, or actively pushed to client module 212 using a live persistent connection.

Web service object remoting is a protocol and system for remoting objects through web services for the plurality of client devices 104. A data Web service is a generic web service that forms an endpoint. The data Web service exposes an “InvokeMethod” Web service method which receives a “InvokeMethodRequest” request object. Network development platform 310 processes the request and gathers information to be sent back to client module 212. The “InvokeMethodRequest” request object is sent as a parameter with the “InvokeMethod” method invocation. The “InvokeMethodRequest” request object contains the following fields: a target data object reference; a method name that represents the method name for the “DataObject”; a collection of method parameters; and/or a return value selector including the suggested paths of the data that should be retrieved. In an exemplary embodiment, a method parameter may be any of the following types: “WebServiceDataObjectReference”, “WebServiceValue”, “WebServiceArray”, “WebServiceNullValue”, and “WebServiceDataPropertyReference”. Network development platform 310 may choose to send more or less data than requested, depending on security, optimization, and performance considerations.

A “WebServiceDataObjectReference” may be a triplet of values that identify a single object instance in network development and hosting system 100. The triplet of values includes an “ObjectBaseId” where the “DataObject” is stored; a class identifier, which is of the type of the “DataObject” instance, and a “DataObjectId”, which is a unique identifier of the “DataObject”. “WebServiceValue” is an abstract primitive value container that includes a string value that identifies the type of the represented value and a string value that can be converted to the specified class. A “WebServiceArray” is a collection of “WebServiceParameters”. A “WebServiceNullValue” denotes a null value. A “WebSerivceDataPropertyReference” extends the “DataObjectReference” container with a string that identifies the property name that is referenced. The “WebSerivceDataPropertyReference” may include an identifier of the ObjectBase where the “DataObject” is stored; a class identifier, which is the type of the “DataObject” instance; a unique identifier of the DataObject; and a string that identifies the property name that is referenced.

A “WebServiceResponse” contains instructions to a serializer to describe what data needs to be serialized. During execution, methods may update the “WebServiceResponse” object according to their needs (security, optimization, and other considerations). The “WebServiceResponse” object includes a return value, a return value selector and pairs of objects and selector strings. The return value parameter includes the value that will be returned to client module 212 as the direct return value of the method invocation. The return value selector includes a string that represents the suggested paths of the data that should be retrieved from the returned value. The pairs of objects and selector strings describe which additional objects should be serialized to client module 212, and the suggested paths for data that should be sent. A “WebServiceContext” is created for each request and includes a “WebServiceRequest”, a “WebServiceResponse”, and a “DataSession”.

To send changes back to client module 212, after an “InvokeMethod” call, a response object is filled with a return value of the invoked method, a data path selector, and an additional collection of objects that network development platform 310 identifies to send to client module 212 without being asked explicitly (identified as forced objects). Two objects are created: an instance of “ClientSerializer” and an instance of “CodeWriter” that transforms simple tasks to client-readable instructions, depending on the host environment. The “ClientSerializer” instance represents a context of referenced objects. This way, if an object A is serialized to client module 212, the object A is given a unique name that is accessible in the immediate context, commonly a variable name. When this object is later referenced by object B, the unique name is used, without requiring that the object be identified again from a memory associated with first client device 110 such as memory 206. Additionally, cross-references between objects can be serialized. The object exposes a “SerializeDataObject” method and a “SerializeDataObjectChange” method. When building the response to client module 212, the “SerializeDataObject” method is called with the returned value and its data path selector. The “SerializeDataObject” method is called again for each forced object with its data path selector. “SerializeDataObjectChange” is called for each pending event log entry.

The “ClientSerializer is a service that transforms the “WebServiceResponse” into a format readable by client module 212. The “WebServiceResponse” is divided into two segments. The first segment includes a direct result of the method invocation, including additional information network development platform 310 chooses to send to client module 212. If client module 212 already has the returned object in its state, a reference instruction is sent. Otherwise, a new object is serialized from network development platform 310 to client module 212. The second segment includes a collection of changes committed from all of the “ObjectBases” that have not yet been sent to client module 212 and that are relevant to client module 212. A lazy-loading implementation may be employed to allow the sending of fragments of data to client module 212 as needed, instead of complete objects that may be too large or not required. Similarly, a greedy-loading implementation may be employed to allow sending data to client module 212 without an explicit request. The data provided without an explicit request is determined to be likely to be needed later in the session. Sending the data before a request may decrease transmissions to/from server 108. For example, a customer instance may contain a customer's name, email, and a collection of purchases made by the customer. When serializing a customer to first client device 110, the customer's name is serialized because it is a primitive, includes a small amount of data, and is used frequently throughout the application. In comparison, the collection of purchases may contain a large volume of data which may not even be used at first client device 110. As a result, the collection of purchases may not be serialized until a client device accesses the collection of purchases for the first time. If UI manager 1400 is asked to display a form containing a customer and their purchases, UI manager 1400 verifies that all of the data that needs to be displayed is loaded to avoid multiple small lazy loading requests. UI manager 1400 can perform this function because UI manager 1400 can access the ClassPath and MemberPath attributes of the controls UI manager 1400 renders. As a result, UI manager 1400 can foresee the data that will be needed, and, using the web service selectors, specifically request the needed data.

The “CodeWriter” is an implementation-specific object that is responsible for creating a set of instructions in a specific order, optimizing the set of instructions when possible, and generating the final string sent to client module 212. The “CodeWriter” exposes the “DataObject” serialization methods included in Table I.

TABLE I

| Method | Description |
|---|---|
| WriteGetDataObjectForLoading | Generates an instruction to create a |
| | new “DataObject” of the given |
| | “ClassElement” and with the given |
| | unique identifier into a given (local) |
| | variable name. A “ClassElement” is a |
| | “DataObject” and is referenced by a |
| | variable name. |
| WriteGetDataObjectFromPool | Generates an instruction to find an |
| | existing “DataObject” in client |
| | module 212's memory. |
| WriteInitializeCollectionProperty | Generates an instruction to create a |
| | new, empty collection property |
| | and to initialize the instruction with |
| | the specified item references. |
| WritePropertyInternalSetValue | Generates an instruction to set an |
| | object's data property to a specified |
| | primitive or reference value. |

The “CodeWriter” exposes the “DataObjectChangeEvent” serialization methods included in Table II.

TABLE II

| Method | Description |
|---|---|
| WritePropertyAddValue | Generates an instruction to add an item to |
| | an existing collection. |
| WritePropertyRemoveValue | Generates an instruction to remove an item |
| | from an existing collection. |
| WriteCollectionBulkStart | Generates an instruction to notify client |
| | module 212 of a bulk change start. |
| WriteCollectionBulkEnd | Generates an instruction to notify client |
| | module 212 of a bulk change end (see |
| | previous method). |
| WriteRenameDataProperty | Generates an instruction to rename an |
| | object's data property. |
| WriteDeleteDataProperty | Generates an instruction to delete an |
| | object's data property. |

As seen in Tables I and II, the “CodeWriter” methods can be divided into methods that deal with serializing DataObjects and a data selector path and methods that deal with serializing changes on existing objects. In an exemplary embodiment, objects that are new to client module 212 are serialized using “DataObject” serialization methods. Objects that are already known to client module 212 are serialized using the methods from the “DataObjectChangeEvent” serialization methods.

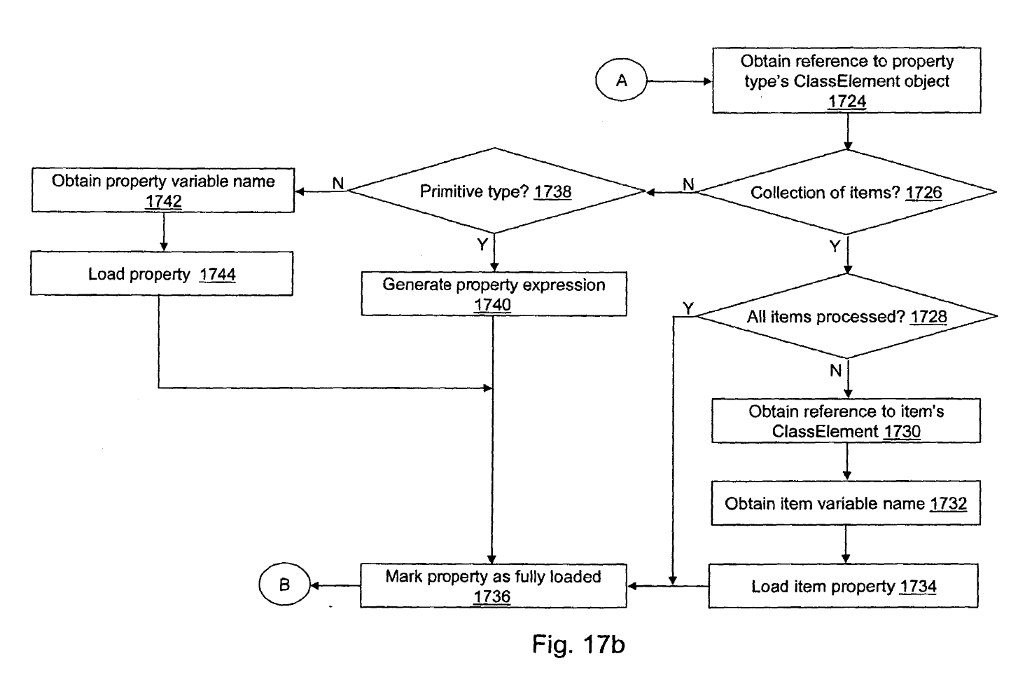

With reference to FIGS. 17a and 17b, a SerializeDataObject process is shown in accordance with an exemplary embodiment. In an operation 1700, a local variable name is obtained for the DataObject's class. Because it is a “DataObject” as well, this process is recursive. In an operation 1702, a local variable name is obtained or generated for the object. In an operation 1704, a determination is made concerning whether or not the object is already on first client device 110. If the object is already on first client device 110, processing continues in an operation 1706. In operation 1706, the variable name of the object is returned, unless it is explicitly requested in the selector path. If the object is not already on first client device 110, processing continues in an operation 1708. In operation 1708, a determination is made concerning whether or not the object is being serialized or has already been serialized previously in this session. If the object is being serialized or has already been serialized previously in this session, processing continues in an operation 1710. In operation 1710, the variable name of the object is returned.

If the object is not being serialized or has not already been serialized previously in this session, processing continues in an operation 1712. In operation 1712, the new variable is given a value. In an operation 1714 a determination is made concerning whether or not the object already exists in a memory of first client device 110. If the object is already on first client device 110, processing continues in an operation 1716. In operation 1716, the “WriterGetDataObjectFromPool” method is called to retrieve the object. If the object is not already on first client device 110, processing continues in an operation 1718. In operation 1718, the “WriteGetDataObjectForLoading” method is called.

The data properties of the data object are processed in an iterative manner. In an operation 1720, a determination of whether or not all of the data properties of the object have been processed is performed. If all of the data properties have been processed, processing continues in an operation 1722. In operation 1722, a “ClientState” is set to “Fully Loaded” to indicate that the object has been fully loaded. If not all of the data properties have been processed, processing continues in an operation 1724. The serializer determines whether the property should be serialized, depending on the data path selector, serialization metadata, and if the data property is already loaded. For example, by default, primitives may be greedy loaded unless the primitive is specified as very long, whereas pointers and collections may be lazy loaded unless the pointers and collections are empty or contain references to instances that are already on first client device 110. Additionally, metadata may be added to a certain property which instructs the serializer to use a greedy, a lazy, or no serialization paradigm. Also, the data path selector may include an explicit request for serialization of the object.

In operation 1724, a reference to the property type's “ClassElement” object is obtained. In an operation 1726, a determination of whether or not a property type of the property is a collection of items is performed. If the property type of the property is a collection of items, processing continues in an operation 1728. In operation 1728, a determination of whether or not all of the items of the collection of items have been processed is performed. If not all of the items of the collection of items have been processed, processing continues in an operation 1730. In operation 1730, an item reference to the item's “ClassElement” is obtained. In an operation 1732, “SerializeDataObject” is called using the item reference to obtain an item variable name. In an operation 1734, “WriteLoadCollectionProperty” is called with the item variable name. In an operation 1736, a “ClientState” is set to “Fully Loaded” to indicate that the property has been fully loaded and processing continues at operation 1720. If all of the items of the collection of items have been processed, processing continues in operation 1736.

If the property type of the property is not a collection of items, processing continues in an operation 1738. In operation 1738, a determination of whether or not a property type of the property is a primitive type is performed. If a property type of the property is a primitive type, processing continues at an operation 1740. In operation 1740, a property expression is generated that can be evaluated at client module 212 to determine the same value of the property at client module 212, and processing continues in operation 1736. For example, a “DateTime” structure is converted into a new Date( . . . ) expression at the Javascript client. If a property type of the property is not a primitive type, processing continues at an operation 1742. In operation 1742, “SerializeDataObject” is called using the property reference to obtain a property variable name. In an operation 1744, “WritePropertyInternalSet Value” is called with the property variable name and processing continues at operation 1736.

A “SerializeDataObjectChangeEvent” process is executed to handle an event. The “SerializeDataObjectChangeEvent” process includes retrieving a reference to the “Target DataObject” of the event. A proper instruction is generated depending on the action and values associated with the event. The Serializer notifies the “ClientState” that the event is serialized which causes the “ClientState” to remove the Event entry from an event entry collection.

JavaScript object remoting is a protocol used to share objects between a client that supports JavaScript and a server. “DataObjects” are serialized to client module 212 as JavaScript code, which client module 212 evaluates dynamically. When attempting to execute a method in a network development platform 310 “DataObject”, client module 212 automatically transmits the method invocation to network development platform 310, network development platform 310 executes the transmitted method, serializes the method return value, and serializes any changes that occurred on “DataObjects” that are relevant to client module 212. By default, “DataObjects” may not be serialized entirely to client module 212. For example, properties that may contain large amounts of data may be lazy serialized on the first attempt of a client to access them. The serialization behavior is controlled through metadata over the “DataObjects”, and through explicit requests from client module 212. Client module 212 may request to receive specific properties to a specific depth to display a specific portion for example of second user interface 500.

Data application 1416 acts as a central dispatch for requests. Each request is allocated a separate thread and a context, and processed in a specific handler, according to the requested address. Data application 1416 hosts many “ObjectBase” Applications or “DataServices” and exposes a resolution service by which a hosted service can be identified using a string. Data application 1416 begins a booting process after a first request. As part of the booting process, a handler scans a predefined directory of managed-code assemblies. Each assembly in the predefined directory is augmented into a platform package, by constructing the equivalent augmented structure elements. As a result, a managed-code assembly that supports reflection, can be transformed to a standard package, every class/interface/enum declared inside the assembly transforms to a “ClassElement” instance with a reference to its originating technology specific implementation. Furthermore, any method/property/event that is declared through the assembly is converted to the proper abstract package element with a reference to its originating technology specific implementation. Technology specific custom attributes may be converted to metadata elements using naming convention/metadata hints. For example, “StyleIconAttribute” instances may be converted to “StyleIconMetadata” instances.

In an exemplary embodiment, a first assembly scanned is a core assembly, which includes super-structure elements required for further network development platform 310 execution. The super-structure elements include the native language required by network development platform 310. The handler creates a single instance of a “DataApplication” class, which serves as a programmatic interface to a global persistence storage, in which each item is an “ObjectBase” that allows entities to persist and to execute logic as defined in a separate super-structure “ObjectBase”. The super-structure “ObjectBase” is referred to as a “MetaBase”.

A “DataSession” denotes a conversation between client module 212 and network development platform 310, in which client module 212 and network development platform 310 share “DataObjects”, and perform operations on the “DataObjects”. Network development platform 310 informs client module 212 of any change on a “DataObject” that occurs on network development platform 310 that is relevant to client module 212. Any method that exists on a remote “DataObject” (even if executed from client module 212) may be invoked on network development platform 310, conforming to the predefined security metadata matching the execution scenario. A “DataSession” includes a collection of “ClientState” objects, a reference to the user at first client device 110, a dedicated “ObjectBase” that stores the session-based information, and a collection of connected “ObjectBases”. A “ClientState” includes an object graph that specifies for each object and data property whether it is loaded at client module 212, a collection of pending “DataObjectChangeEventArgs” that have yet to be sent to client module 212, and a collection of monitored “ObjectBases”.

In an exemplary embodiment, in an execution of network development and hosting system 100, a user accesses system 100 by browsing to a web server hosting the platform. For example, the user may browse to first user interface window 400, login, and select application link 408 and/or development link 410. Network development platform 310 accepts the HTTP request and hands it to a platform handler. The platform handler ensures that the single instance of a “DataApplication” class is started. Data application 1416 hands the HTTP request to a specific “ObjectBase”, as defined in the HTTP request header. The “ObjectBase” hands the HTTP request to a specific hosted service as defined in the HTTP request header. The service instance is sent back to client module 212 for further execution. In an exemplary embodiment, client module 212 retrieves HTML metadata elements for the service and renders it using browser application 210. Client module 212 continues to interact with the service by invoking methods and retrieving application and session bound data. With each client request, network development platform 310 acts as a state machine by executing logic as defined in the associated “ObjectBase”. With each response, client module 212 is sent a set of native instructions in order to re-synchronize to the new state. Instructions are optimized based on the previous client state, and various other parameters such as predefined serialization and security metadata. In an exemplary embodiment, the browser application 210 presents data-bound controls. With each state change, controls dynamically update to reflect the recent state changes. “DataObjects” can be services, processes, business objects, application objects, raw data, etc.

Logical data layer 1418 includes super-structure elements that construct an entities structure and logic. In an exemplary embodiment, logical data layer 1418 includes a package object model 1422, a metadata model 1424, and a dynamic code model 1426. Package object model 1422 includes the super-structure elements that construct data-centric entities. Metadata model 1424 includes super-structure elements that augment the object model. Dynamic code model 1426 includes super-structure elements that construct dynamic entities logic.

Package object model 1422 includes both super structure and structure elements that are native platform data objects. Because network development platform 310 utilizes a unified model to dynamically respond to data changes, no recompilation is required when a structure is modified. Additionally, packages can contain descriptive metadata and code logic. Super structure elements serve as the basis for object model augmentation and are stored in a package. A package describes an abstract model and contains classes, interfaces, members, and additional metadata for each element. A package may refer to other packages and extend or use their model. All package elements are “DataObjects”. As such, they support persistence, remoting, and event notifications and transactions. A package element can be inferred from assemblies, code files, or be created dynamically at runtime.

A class contains a set of members. A member may be a property, a method, an event, an inner class, or metadata. Each class exposes four interfaces: “OnLoading”, “OnReading”, “OnChanging”, “OnChanged”. “OnLoading” executes before an instance is read from persistent storage. “OnReading” executes as a property of the instance is read from memory. “OnChanging” executes before the instance is about to change one of a property value of the instance. “OnChanged” executes after a property value of the instance is changed. This interface provides a generic way to dynamically invoke logic for each change that occurs in a data object. Because logic can be dynamically attached as dynamic code elements, no compilation is required to evaluate recent changes.

A property is defined by its type, and access methods that provide an interface to a value of the property. A “Getter” method returns an encapsulated value (either predefined or calculated), and a “Setter” method modifies the value of the property. A property may calculate its value instead of storing it. In this case, the “Getter” method does not automatically read the encapsulated value. Instead, the appropriate code element is invoked, and the result is returned. Each calculated property maintains a set of dependency paths. These are defined to be the paths that may affect the calculated value. Which paths need to be monitored can be detected for a given instance by analyzing the “Getter” method code. The detected paths can be monitored and the property value refreshed based on the monitoring.

A method encapsulates logic and statements that are either hardcoded (available in machine code as a compiled library) or scripted (written in a scripting language). A method accepts parameters and has a return value. Each method exposes two interfaces: “OnInvoking” and “OnInvoked”. “OnInvoking” executes before a method is executed and allows interception of the invocation, cancellation of the invocation, and returns a custom value for the method invocation. “OnInvoked” executes after a method is invoked. The “OnInvoking”/“OnInvoked” interface is a generic interface that allows intervention in any method's execution. Method specific interfaces can be created using a metadata/naming convention. For example, a “Customer” class including a “BuyProduct” method, may define a “OnBuyProductInvoking” to register as a method specific intervention point.

An event is a collection of references to methods and/or method plus instance pairs called event handlers. An object can subscribe to events on another object. When an event is “fired”, all of the methods in the collection are invoked. By default, these methods may be invoked in a synchronous manner. By default, data objects may expose events of any property change, before and after the change occurs. Additionally, when an event occurs on an object that is a part of an entity in a composition, that event bubbles up recursively until it reaches the composition root. For example, if an entity called a hand has a number of fingers, and each finger has a single fingernail, whenever the color property of the fingernail changes, the finger object and the hand object are notified. Each “DataObject” supports events that happen on the “DataObject” itself, such as the fingernail, and events that happen on the entity which is rooted by that “DataObject”, such as the hand entity.

Any element may support metadata. Metadata supports dynamically inferred information. For example, a property of type “String” may have a “DbColumnMetadata” inferred to instruct an object/relational (O/R) mapper to persist the property to a specific column in a database such as database 109.

Platform data objects natively support associations where an association is defined between two endpoints at the structural level and are enforced at the instance level. The O/R mapper takes them into consideration when constructing the database. A unidirectional association between objects A and B, means that object A refers to object B. Object B, however, is not aware of objects that refer to it. A bidirectional association between objects A and B, means that object A refers to object B, and object B refers back to object A.

When defining an association, an association type can be defined in which an object composes other objects. For example, a hand object may be composed of five finger objects. An object and all of its composed objects (directly and indirectly) is called an entity. A composing object controls the lifetime of its composed elements. When it is deleted, the composed elements are deleted. When it is created and accessed, the composed element is instantiated.

Metadata model 1424 supports super-structure elements that augment traditional object-oriented models (classes, properties, methods, and events) with an extensible metadata layer. Metadata provides predetermined and calculated parameters to abstract algorithms that perform various platform tasks. Input required for an application's algorithms to execute is encapsulated on top of the object model itself to define a self-describing model that exhibits high portability across different implementations and platforms. Metadata is provided as attributes attached to data or structural elements. Metadata elements are implemented as data objects, which automatically enables them to be persistent to any data storage and to be serialized to any medium. In an exemplary embodiment, a metadata attribute includes a triplet of a name, a value, and a key. The name describes the attribute. For example, “StyleIconMetadata” represents the icon for the element being described. The value represents the actual value of the attribute. For example, “StyleIconMetadata(“MyIcon.gif”)” states that the element is decorated with an icon and that the value for the icon is “MyIcon.gif”. The key represents the usage scope for the name-value set to enable the creation of preset metadata that allows different inputs in different execution scenarios. The following examples illustrate the mechanism:

//Providing access level metadata for two different user groups
[SecurityAccessLevelMetadata(Key=Default, Value=1)]
[SecurityAccessLevelMetadata(Key=Admin, Value=5)
public class Contact : DataObject...
//Providing terminology metadata for two different languages
[TerminologyNameMetadata(Key=English, Value=“Customer”)]
[TerminologyNameMetadata(Key=Spanish, Value=“Cliente”)]
public class Contact : DataObject...
//Providing serialization metadata for three different bandwidths
[SerializationSchemaMetadata(Key=HighBandwidth, Value=Greedy)]
[SerializationSchemaMetadata(Key=NormalBandwidth, Value=Lazy)]
[SerializationSchemaMetadata(Key=NarrowBandwidth, Value=None)]
public class Contact : DataObject...

By default, metadata is provided at the structural level. Each metadata attribute is attached to a package element such as a class, a property, a method, or an event to allow retrieval of metadata information for any instance of a data object in system 100 simply by querying its structure using minimal definitions. The behavior can be extended up the inheritance hierarchy and down concrete instances of classes. To support, up the inheritance hierarchy, metadata can be defined in an abstract manner over base classes. For example:

//Person class explicitly defines icon metadata
[StyleIconMetadata(“Contact.gif”)]
public class Contact : DataObject...

Metadata elements may contain static data that is outside the scope of the model. For example:

[StyleIcon(“contact.gif”)]
public class Contact : DataObject
{
}

Metadata elements may also reference other model elements from within the scope of the model such as properties, methods, etc. For example:

```
[StyleIconProperty(Image)]
public class Contact : DataObject
{
  public string Image
  {
    get;set;
  }
}
```

Metadata may be inherited. A metadata element defined on a base class may be valid for derived classes and may also be valid for properties or methods of that type (unless explicitly defined on that property/method). For example:

```
//Customer class implicitly inherits the StyleIcon metadata from first
example)
Public class Customer : Contact
Public class Phone
{
  //The StyleIcon metadata may be valid here as well.
  Public Contact Contact
  {
    get;
    set;
  }
}
```

During execution, sub-system implementations can query data objects for metadata. A metadata matching process includes searching a metadata cache repository, searching metadata directly over a provided instance, searching metadata over a class or member, and/or moving up the inheritance hierarchy. In moving up the inheritance hierarchy, if the target is a “ClassElement”, the inheritance tree is searched up to a “DataObject” class. If the target is a property element, the property is searched, the property type is searched, and the inheritance tree is searched up to that type. If the property is a collection property, a collection item type is used as the base for the hierarchy search. The first available result is cached. The cached value may change as the search continues. The cached value is returned at the completion of the search.

Dynamic code model 1426 supports method code elements, event handler code elements, and markup code elements. A method code element may include constructor initialization logic, business logic methods, etc. An event handler code element may include property change handlers, custom event handlers, etc. A markup code element may include HTML forms, CSS, JavaScript, etc.

Code elements are stored in a package. Each code element maintains an unparsed code text property and links to dependent code elements. When invoked, network development platform 310 ensures that the code element and its dependencies are properly parsed. Code elements are not used to describe structure, but instead describe only logic. Code elements are data object themselves. Each method, event handler, or markup code element can be persisted, serialized, and remoted just as any other platform data object. The following block of code uses classic object oriented design paradigms.

```
public class Contact
{
  public void SendMessage(string message)
  {
    //Send Message Logic...
  }
  string _Name;
  public string Name
  {
    get { return _Name ; }
    set { _Name = value; }
  }
  public event EventHandler NameChanged;
  protected void OnNameChanged( )
  {
    //Name Changed Logic...
  }
}
```

A code design according to the described paradigm includes a Contact class element that includes a SendMessage method code element that includes the send message logic. The SendMessage method code element also includes a Name property element. The Name property element includes a NameChanged event code element that includes the name changed logic.

Persistent data layer 1420 supports sub-systems that handle entities persistence in terms of medium, scope, and atomicity. Persistent data layer 1420 may include a “DataObject” model 1428, an “ObjectBase” model 1430, and a relational model 1432. “DataObject” model 1428 includes structure elements that construct live data object instances. “ObjectBase” model 1430 includes elements that construct an entity persistence medium. Relational model 1432 includes elements that construct a relational persistence medium.

Data objects are the base building blocks for objects that contain data and logic. A “DataObject” is an instance of a “ClassElement”. Data objects share a common interface by which they notify system 100 concerning a method invocation or a property value change. The notification mechanism supports persistence, serialization, remoting, interception, and additional services.

A data property represents an instance of a property element. The data property includes a reference to the value, to the property element, and to the data object that owns it. The value may be a primitive value, a reference to another data object, or a collection of references to data objects. The data property notifies its data object of any changes, before and after they occur. Additionally, the data property notifies the parent object of each read and write event that occurs. The data property is dynamic in the sense that the data property can transform from encapsulating a data type and property mode to another data type and/or mode. For example, the data property can transform from encapsulating a primitive value to encapsulating a collection of references to objects.

A collection is a group of data objects. The collection can be ordered, with or without repetitions, indexed, and queried. When a data object includes a collection as a property, the data object receives notifications before and after any action that occurs relative to a member of the collection. The collection becomes an inseparable part of the data object, and the data object has full control over the collection. For example, as shown below PhoneNumbers is a collection property of Contact. The instance contact is notified before and after an action occurs. The instance contact may choose to cancel the action or perform some other logic.

Contact contact=new Contact( );
contact.PhoneNumbers.Add(new PhoneNumber(“09-7467283”));

A data method represents an instance of a method element. A data event represents an instance of an event element.

ObjectBase model 1430 includes elements that construct an entity persistence medium. In an exemplary embodiment, an “ObjectBase” is an object-oriented database. Each “ObjectBase” contains a reference to a package, and stores zero or more instances of “ClassElement” entities that are defined in the package and its referenced packages. An “ObjectBase” natively supports entity queries, modifications, transactions, remoting, and persistence. An “ObjectBase” stores its data objects in an instance of a class that derives from a “RootDataObject” class. The “RootDataObject” class is generated during runtime, and contains a collection property for each of the contained instances' classes. The class represents the structure of the “ObjectBase” and is referred to as a root class. Each property of the root class is called a root property. The single instance of the root class is called a “RootDataObject”, and each “DataProperty” inside the “RootDataObject” is called a “RootDataProperty”. In an exemplary embodiment, a “RootDataProperty” maps to a table of “DataObjects” of a specific type.

Each change that occurs within a “DataObject” attached to a given “ObjectBase” is recorded in the ObjectBase's event log. The event log is a collection of “DataObjectChangeEventArgs” objects. The event log may be monitored by various sub-systems to achieve database persistence and client serialization. The event log provides the main communication interface between the subsystems across the platform.

“DataObjectChangeEventArgs” encapsulates an atomic change within a given “DataObject”. Each change object has an action property, a phase property such as “before” or “after”, a “DataObject” property such as the instance that is being changed or has been changed, a “DataProperty” property, and the values of the property before and after the change has occurred. The action property can be to add an item to a collection, to remove an item from a collection, to set a property value, to begin a significant change event on a collection such as a clear, to end the significant change event, to transform a “DataProperty” from a primitive to a pointer or to a collection, etc.

ObjectBases support transactions. Each action over an attached data object (that is, a data object that is known to be stored in a certain “ObjectBase”) may occur within the context of a transaction. When two users, in two different threads, try to access the same “DataObject”, system 100 determines which user can go first to avoid data corruption. For example, system 100 may give access to the first user that requests the object with a timeout mechanism that may roll back and cancel the transaction if the object is not available in that time.

From an “ObjectBase” point of view, a “DataObject” is either attached to an “ObjectBase”, or detached (does not belong to any “ObjectBase”). Because an “ObjectBase” is responsible for recording object changes, the “ObjectBase” can identify when a “DataObject” that is stored in the attached “ObjectBase” refers to a detached “DataObject”. When such an object is detected, the detached “DataObject” is automatically attached to the “ObjectBase”. This behavior can be overridden by explicitly defining an auto-attach metadata for a given “DataProperty” or “DataObject”.

In an attachment process, a request to attach a “DataObject” into an “ObjectBase” is received. If the “DataObject” is already attached to the “ObjectBase”, the “RootDataProperty” is retrieved for the DataObject's class, and a reference to the “RootDataProperty” added to that collection. If the “RootDataProperty” does not exist, the “RootDataProperty” is automatically created, unless the “ObjectBase” is instructed to exclude attachment of the given type for design or security reasons. The associated “DataObjects” are iterated over and attached recursively.

ObjectBases can be queried to allow system 100 and a user of first client device 110 to search for a particular object. In an exemplary embodiment, the syntax for “ObjectBase” queries follows the object query language standard. An “ObjectBase” also denotes a storage unit. The storage may be a database file, extensible markup language file, or any other supported format. The support of different formats is achieved by implementing a “PersistenceProvider” class. A persistence provider connects to an “ObjectBase” and persists any object and any modification of an object to the persistent storage. For example, a common storage space is database 109 implemented as a relational database. A “DbPersistenceProvider” provides the necessary behavior to map between groups of objects with a certain model to a relational database. “DataObjects” support persistence natively as the platform provides default O/R mapping and persistence metadata. The mapping can be controlled via metadata attributes, or using custom code. The “DbPersistenceProvider” supports lazy-loading and lazy-creation of data structures, when they are required. For example, there is no need to create a table for a Contact, when it has no actual instances. When the first instance is created and stored, the table can be created.

Typically, when a persistence provider is created, the persistence provider subscribes to object-model changes such as adding a “PropertyElement” to a “ClassElement”, and also to data changes. Additional persistence providers can delegate persistence to a remote service. For example, an online shop service can retrieve and store shopping cart items from a remote web service. As another example, email messages can be retrieved and sent from a simple mail transfer protocol service.

A “DataObject” is a runtime instance of a “ClassElement”. When instantiated, the “DataObject” becomes aware of that “ClassElement”, and treats it as a blueprint for all of its behaviors. For example, the “ClassElement” includes actual properties and methods as defined in the “ClassElement”. However, since the class, property, and method elements are all objects, they may change during runtime. When that happens, network development platform 310 reflects those changes onto the instances of the class.

Dynamic object relational mapping is achieved by propagating and enforcing model changes onto existing live data object instances. The logic is implemented in an “ObjectBaseBuildManager” class. When an “ObjectBase” is created or reloaded, an “ObjectBaseBuildManager” is created. The build manager refractors data object instances to reflect any model change according to model change rules. When a property is added for a class C, all the instances of class C are iterated over, and the data property is added to each instance. When a property is removed from a class C, all the instances of class C are iterated over, and the data property is removed from each instance. When a name of a data property is changed, all the instances of class C are iterated over, and the data property name is changed for each instance. When class C is removed, all instances of class C are deleted. When a data type of a data property is changed, all the instances of class C are iterated over, and the value of the data property is converted based on the data property change for each instance. Table III includes conversion rules.

TABLE III

| From type | To type | Actions |
|---|---|---|
| Primitive | Primitive | Use native type conversion |
| Primitive | Pointer | Convert the primitive value to a string and treat it as the |
| | | object's name. Search for an instance of the pointer type |
| | | with a matching name. If none are found, instantiate a new |
| | | “DataObject” and assign it the specified name. |
| Primitive | Collection | Convert the primitive value to a string, split the string |
| | | using a delimiter such as a comma. For each token, use |
| | | the same logic as the Primitive->Pointer conversion, and add all |
| | | the objects to the newly instantiated object. |
| Pointer | Primitive | Use the object's Name. |
| Pointer | Pointer | Extract the DataObject's name, and look for an existing |
| | | “DataObject” with that name. If none are found, create a |
| | | new “DataObject” and assign the new “DataObject” the extracted |
| | | DataObject's name. |
| Pointer | Collection | If the pointer and collection item types are the same, add |
| | | the pointer to the newly created collection. As a result, |
| | | converting a phone number field of a contact to a list of |
| | | phone numbers results in no loss of data. If the pointer |
| | | and collection item types are not the same, use the same logic as |
| | | the Pointer->Pointer conversion. |
| Collection | Primitive | Create a string that consists of the names of the objects, |
| | | separated by a delimiter string. |
| Collection | Pointer | If the pointer and collection item types are the same, |
| | | truncate the collection to the first instance or null if it was |
| | | empty. If the pointer and collection item types are not the |
| | | same, use the same logic as the Pointer->Pointer |
| | | conversion on the first item of the collection. |
| Collection | Collection | Use the same logic as the Pointer->Pointer for each item in the |
| | | collection, and add it to the newly created object. |

The default behavior of the conversion can be overridden with the use of metadata or specific directives at the “ObjectBaseBuildManager”.

A data object can be requested to be deleted in a scope of an “ObjectBase”. To delete an instance of a data object, determine if the object is already marked as being deleted. If so, no further processing is required. If the object is not already marked as being deleted, the object is marked as being deleted. If the object is an entity with composed properties, the composed properties are recursively deleted. All references to the object are removed. The data of all pointers and collections are cleared to null and collections are emptied. All primitives are cleared. The object from the “RootDataProperty” of its class is removed. The object is marked as deleted.

Relational model 1432 contains elements that construct a relational persistence medium. Relational model 1432 includes an abstract relational database model and components that map between the relational model and the data object model. “DbModel” is an abstract model of a physical relational database. The “DbModel” includes schemas, tables, columns, relationships, and indexes, which are referred to as “DbElements”. “DbElements” are “DataObjects”, and their model is described using a standard object model.

A service named “DbSchemaAdapter” synchronizes between, for example, database 109, and an abstract, in-memory database model, using a driver called “DbAdapter”. The “DbSchemaAdapter” service also listens to “DbModel” changes and reflects them in the physical database using structured query language (SQL) queries. An O/R mapper creates and/or updates a “DbSchema”, and a “DbSchema” may be connected to a “DbSchemaAdapter” so the O/R mapper can synchronize its relational in-memory model with a real database model.

The O/R mapping schema maps between a package and a “DbModel”. A package element is mapped to one or more “DbElements”. The mapping is stored in a data structure called an O/R element. For example, a property named “Birthday” of class “Contact” may be mapped into a “DbColumn” Name in the “DbTable” Contacts. In this example, the O/R Element has two pointers: the property and the instance of the “DbColumn”.

A class mapping includes a pointer to a class element and a pointer to a “DbTable”, an optional pointer to a discriminator column (for inheritance) and a base relationship, which designates the relationship to the table of the base class. A property mapping consists of a pointer to a property element and a mapping type, which can be one of the following types: a primitive, which is a single column inside the table; a many-to-one, which is a secondary column in one table and a primary column in another table, and the relationship between them; a one-to-many, which is a primary column in one table and a secondary column in another table, and the relationship between them; and a many-to-many, which is an intermediate table composed of columns and relationships that point to two other tables, and the two relationships.

The O/R mapper maps between the object model and the relational model. For example, in an exemplary embodiment, in-memory references between one object and another are saved as a reference to its unique identifier. Similarly, a many-to-many association may require another intermediate table to store the unique identifier of both types. Changes to the object model cause the relational model (DbModel) to change accordingly. The OR Mapper subscribes to changes in the object model. When the relational model itself changes, it reflects those changes in the physical database model using SQL statements.

When persisting objects with inheritance, each inheritance level and its declared properties are called a layer. When persisting a “DataObject”, the “DataObject” is persisted in all of its layers. The persistence provider saves it in each layer, starting from the base class's layer. When persisting a layer, the O/R mapping information for the layer is retrieved, auto-creating the necessary mapping information if it does not exist or is not loaded. A row is created in-memory at the layer's table. For each property of the layer, its property O/R Mapping is retrieved with auto-creating enabled. The O/R mapping type of the property is examined to determine additional processing. If the O/R mapping type is primitive, the value of the DataProperty is converted into a single, primitive cell. If the O/R mapping type is many-to-one, a reference to the data object unique identifier is put in the cell. If the O/R mapping type is one-to-many, the objects in the “DataProperty” are iterated over and their rows in the child table are updated to point to the unique identifier of the object. If the O/R mapping type is many-to-many, a row in the intermediate table is added for each object in the “DataProperty”. Once all the “DataProperties” are persisted, the row of the layer is inserted.

When loading objects from the database, the “PersistenceProvider” checks if the object already exists in the given ClassElement's table. If the object already exists, the discriminator column is examined to determine the actual “ClassElement” of the instance. A “DataObject” is created. The “DataObject” is provided with a unique identifier, and each layer is loaded, beginning from the base class's layer. If the object does not exist in the database, the “ObjectBase” is contacted to get the object from a remote site.

When loading a layer, the O/R mapping information for the layer is retrieved without auto-creating, if it does not exist. If no mapping is found, the process marks the “DataProperties” as loaded. The layer's row is retrieved into memory. For each property of the layer, the “DataProperty” is loaded.

When a “DataProperty” is loaded, its property O/R Mapping is retrieved without auto-creating. The O/R Mapping type of the property is examined. If the O/R mapping type is primitive, the cell's value is converted to the required type and stored in the “DataProperty”. If the O/R mapping type is many-to-one, the cell's value, which is the unique identifier of the local or remote object, is loaded, and is converted into a reference which is stored in the “DataProperty”. If the O/R mapping type is one-to-many, the child table is examined and all back-references to the data objects are retrieved. For each row, a reference is created and added to the “DataProperty”. If the O/R mapping type is many-to-many, all of the rows in the intermediate table that has a back-reference to the loaded data object are loaded. For each row, a reference is created and added to the “DataProperty”.

If the entry represents an “Add” command to a “RootDataProperty”, a “SaveDataObject” method is invoked for the added value. If the entry represents a “Remove command” on a “RootDataProperty”, a “DeleteDataObject” method is invoked for the removed value. When a table is required and the table does not exist already, the table is created. Similarly, when a table is required and that table already exists but is unused, the table is used.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”.

The exemplary embodiments may be implemented as a method, apparatus, or article of manufacture using standard programming and/or engineering techniques to produce software, firmware, hardware, or any combination thereof to control a computer to implement the disclosed embodiments. The term “computer readable medium” can include, but is not limited to, magnetic storage devices (e.g., hard disk, floppy disk, magnetic strips, . . . ), optical disks (e.g., compact disk (CD), digital versatile disk (DVD), . . . ), smart cards, flash memory devices, etc. Additionally, it should be appreciated that a carrier wave can be employed to carry computer-readable media such as those used in transmitting and receiving electronic mail or in accessing a network such as the Internet or a local area network (LAN). The network access may be wired or wireless.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein without deviating from the spirit of the invention. Additionally, the order of execution of the functions may be changed without deviating from the spirit of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A device comprising:
a processor;
a memory operably coupled to the processor;
a communication interface operably coupled to the processor to receive a request to access a network development platform from a client device; and
a computer-readable medium operably coupled to the processor, the computer-readable medium comprising instructions that, upon execution by the processor, perform operations comprising
process the request from the client device, the request including an application identifier of an application to develop and an object identifier of an object associated with the application;
confirming that an instance of a programmatic interface to a persistent storage associated with the application is executing using the application identifier;
identifying a service instance associated with the object using the object identifier, wherein the service instance is configured to modify a user interface of the client device to present the object; and
sending the identified service instance to the client device.

2. A computer-readable medium comprising computer-readable instructions therein that, upon execution by a processor, cause the processor to support an integrated development environment at a client device, the instructions configured to cause a computing device to:
receive a request to access a network development platform from a client device, the request including an application identifier of an application to develop and an object identifier of an object associated with the application;
confirm that an instance of a programmatic interface to a persistent storage associated with the application is executing using the application identifier;
identify a service instance associated with the object using the object identifier, wherein the service instance is configured to modify a user interface of the client device to present the object; and
send the identified service instance to the client device.

3. The computer-readable medium of claim 2, wherein the request further comprises an action associated with the object identifier.

4. The computer-readable medium of claim 3, wherein the action comprises requesting a value of the object.

5. The computer-readable medium of claim 3, wherein the action comprises at least one of adding a first property to the object, removing a second property from the object, changing a property name of a third property of the object, deleting the object, and changing a property type of a fourth property of the object.

6. A method of supporting an integrated development environment at a client device, the method comprising:
receiving a request to access a network development platform at a server from a client device, the request including an application identifier of an application to develop and an object identifier of an object associated with the application;
confirming that an instance of a programmatic interface to a persistent storage associated with the application is executing at the server using the application identifier;
identifying a service instance associated with the object using the object identifier, wherein the service instance is configured to modify a user interface of the client device to present the object; and
sending the identified service instance to the client device

7. The method of claim 6, wherein the request further comprises an action associated with the object identifier.

8. The method of claim 7, wherein the action comprises requesting a value of the object.

9. The method of claim 8, wherein the service instance is configured to return the value of the object.

10. The method of claim 6, wherein the action comprises at least one of adding a first property to the object, removing a second property from the object, changing a property name of a third property of the object, deleting the object, and changing a property type of a fourth property of the object.

11. The method of claim 10, further comprising saving a record of the action at the server for propagating to a second client device accessing the network development platform using the application identifier.

12. The method of claim 11, wherein the record of the action is saved in a relational database.

13. The method of claim 7, further comprising identifying each instance of the object and performing the action on each instance of the object.

14. The method of claim 6, wherein the service instance is configured to execute in a browser application.

15. The method of claim 6, wherein the object is at least one of a project, a model, a class, a property, and a method associated with the application.

16. The method of claim 6, wherein the request further comprises a plurality of characters associated with instructions for execution of the application.

17. The method of claim 16, wherein the plurality of characters are separated into a plurality of tokens.

18. The method of claim 17, wherein the plurality of tokens are parsed to form a syntax tree.

19. The method of claim 18, wherein the syntax tree is augmented with metadata associated with a token of the plurality of tokens.

20. The method of claim 19, wherein the service instance includes information associated with presentation of the plurality of characters at the user interface of the client device.
